(19) United States
(12) Patent Application Publication
(10) Pub. No.: US 2015/0125947 A1
(43) Pub. Date: May 7, 2015

(54) MICROFLUIDIC DEVICE

(71) Applicant: Scope Fluidics SP. Z O.O., Warszawa (PL)

(72) Inventors: Piotr Korczyk, Warszawa (PL); Ladislav Derzsi, Baka (SK); Tomasz Kaminski, Wilkolaz (PL); Slawomir Jakiela, Krosno (PL); Piotr Garstecki, Warszawa (PL)

(73) Assignee: Scope Fluidics SP Z O.O., Warszawa (PL)

(21) Appl. No.: 14/396,707

(22) PCT Filed: Apr. 25, 2013
(86) PCT No.: PCT/EP2013/058644

§ 371 Date: Oct. 23, 2014

(30) Foreign Application Priority Data
Apr. 25, 2012 (PL) P-398979

(51) Int. Cl. B01L 3/00; B01L 7/00

(52) U.S. Cl. CPC B01L 3/502784; B01L 7/525; B01L 3/502746; B01L 2300/0816; B01L 2300/0864; B01L 2300/0867; B01L 2300/088; B01L 2200/0673; B01L 2400/086; B01L 2400/0406
USPC 435/289.1; 422/502

(57) ABSTRACT

The invention provides a new microfluidic device and method for performing operations on droplets. The invention extends to microfluidic systems comprising one or more of the microfluidic devices.

The invention relates to a microfluidic device and a microfluidic system comprising one or more microfluidic devices. More particularly, the invention relates to microfluidic devices for performing operations on microdroplets flowing in channels of microfluidic systems. In particular, the invention relates to geometries of microfluidic devices that enable i) trapping a droplet in a fixed position, ii) dispensing predetermined droplet volume from a larger volume delivered to a channel, iii) merging two or more microdroplets flowing in a channel, iv) changing distances between droplets flowing in a channel. The present invention comprises also microfluidic systems employing such microfluidic devices to perform complex hydraulic operations on sample volumes. For example, the integration of a few microfluidic devices according to the present invention allows for generation of a sequence of sample dilutions with a buffer to yield sample concentrations decreasing in geometric series in consecutive droplets. In another example, the integration of devices according to the invention allows for generation of a sequence of droplets with predetermined dilution profile and for confinement of these droplets in strictly defined locations in a microfluidic cartridge. Particularly preferably, the systems according to the present invention can be effectively used for assessment of the results of chemical and biochemical reactions performed on small samples of solutions or body fluids. The systems according to the present invention can also be used to perform time- and cost-effective microbiological studies.

A growing number of reports relating to the use of microfluidic systems in chemistry allow to predict rapid development of the lab-on-a-chip technology, consisting in performing experiments and operations on microvolume samples, in near future. Especially promising is the use of droplets generated in microchannels as miniaturised chemical reactors, because of their small volume, ranging from microliters, through nanoliters down to picoliters. Typically, droplet-based microsystems comprise a multiplicity of microfluidic channels, with their inlets and outlets, interconnecting within the microfluidic chip, where droplets of solutions surrounded by immiscible continuous phase are generated. Further, the droplets inside the systems can be merged, transported along the channels while their contents are being mixed, stored under constant or varying conditions, and finally sorted or split in channel junctions and retrieved from the microfluidic system. The use of microlaboratories to conduct chemical and biochemical reactions inside microdroplets offers the following advantages [H. Song, D. L. Chen and R. F. Ismagilov, Ang. Chem. Int. Ed., 45, 2006, 7336-7356]: i) no dispersion of time of residence for fluid elements in a channel, ii) rapid mixing, iii) ability to control easily the kinetics of reactions, iv) ability to conduct multiple reactions in parallel, v) low consumption of reagents. These characteristics make the microdroplet-based microsystems a potentially valuable tool for analytical chemistry, synthetic chemistry, biochemistry, and microbiology. The existing reports on the use of droplet-based microfluidic systems for compartmentalization of chemical reactions include applications in chemical synthesis [A. Griffiths et al., Compartmentalised combinatorial chemistry by microfluidic control, US patent application US20060078893], and in biochemical reactions [A. Hsieh et al., Method and apparatus for rapid nucleic acid analysis, US patent application US20080166720].

One of the challenges related to droplet-based microsystems is to enable i) preparation of each of the micro-mixtures contained in droplets so that they are individually addressable, i.e., that the collection of reagent concentrations in each micro-mixture could be individually settable, ii) conducting long-term monitoring of the progress of reaction or incubation of microorganisms inside the droplet, iii) localisation of droplets at well-defined locations in a microfluidic cartridge, iv) performing iterative titration and replacement of a part of the volume in a predetermined, individually addressable microvolume, and v) performing any combination of the above operations using possibly a simple set of devices supplying the cartridge with flows, in preferred embodiments so that no precise control with external devices is needed to obtain precisely dispensed volumes and precisely predetermined combinations of concentrations of chemical or biologically active agents.

In the state of the art there are robotic stations conducting reactions inside well plates that operate on reaction mixture volumes in the range of single microliters or more, with frequencies in the range of tenths of a Hertz, or less. Likewise, robotic stations conducting reactions inside cells offer reaction volumes ranging from a few tens to a few hundred microliters and the rate of generation of reaction mixtures of tenths of a Hertz. In both techniques, the accuracy of dispensing the volumes of solutions reaches the level of a few percent or better. These techniques require, however, the use of technically complex fluid supply systems and fluid volume dispensing systems.

In the state of the art there are solutions related to generation of microdroplets on demand inside microfluidic systems. M. Unger et al. (Science, 288, 2000, 113-116) constructed a valve comprising two perpendicularly aligned—one above the other—microchannels fabricated in an elastomer. Application of pressure to one of them results in deformation of both channels and closes the lumen of the second channel. This solution is very popular in the microfluidic techniques, with numerous modifications presented, i.a., by S. Hulme et al. (Lab Chip, 9, 2009, 79-86), S. Zeng et al. (Lab Chip, 9, 2009, 1340-1343), and J. Galas et al. (N. J. Phys, 11, 2009, 075027). W. Grover et al. (Sensors Actuators, B 89, 2003, 315-323) presented another popular microvalve. It is a membrane valve controlled by applying a pressure or a vacuum on one side of the membrane resulting in deflection thereof and closure or opening of the lumen of the channel. Churski et al. (Lab Chip, 10, 2010, 512-518, Polish patent application P-388565) demonstrated a modified Grover valve completely fabricated in a stiff material, comprising elastic membrane only.

There are examples reporting the use of external valves for generation of droplets on demand inside a microfluidic system. For example, Churski et al. (Lab Chip, 10, 2010, 816-818, and the Polish patent applications P-390250, P-390251, international patent application PCT/PL2011/050002, published under the number WO 2011 090396 A1, and so far unpublished Polish patent application P-393619) have shown a system using an external valve of a large dead volume, modified with a capillary of appropriate stiffness and hydrodynamic resistance large enough to enable dispensing droplets with volumes in the range of nanoliters with no risk of flooding the microfluidic system by excessive solution.

All the above cited demonstrations do not allow for performing a number of operations on droplets without precise active control over the flow. Such an opportunity is offered by solutions taking advantage of channel geometry and Laplace pressure (related to the surface tension on and the curvature of the surface of a microdroplet). In general, these solutions make use of differences in pressures needed to push continuous fluid that wets the walls of the channels and to push a droplet of a liquid that do not wet the walls of the channels through diverse channel cross-sections. Generally, side intrusions in the lumen of the channel can be used to make the flow of the continuous liquid relatively easier while simultaneously hindering the flow of droplets of the liquid that does not wet the walls of the channels.

In the state of the art there are solutions that take advantage of the cited effects related to the surface tension.

For example, [Niu et al., Lab Chip, 8, 2008, 1837; Guo et al., Appl. Phys. Lett. 97, 2010, 233701] report on devices comprising a chamber with bypasses (i.e., side channels) on both sides of the chamber. Each bypass comprises a number of inlets and outlets along the chamber. The inlets and outlets are formed by short sections of microfluidic channels of a depth such as the main channel, and a width smaller than the main channel. In the cited solution, the width of the main channel in the chamber can be decreasing along the direction of the flow of the liquid. Droplets smaller than the volume of the chamber, of a diameter greater than the width of the chamber, are stopped in the chamber. Subsequent droplet flowing into the chamber merges with the preceding droplet, and if their total volume is greater than the volume of the chamber, the mixture is released. Similar solutions have been reported also elsewhere [Chung et al., Microfluid. Nanofluid., 9, 2010, 1151-1163]. A disadvantage of these solutions is the lack of precision in positioning the first locked droplet. As a result, incoming droplets of virtually different volumes can merge in the trapping device and release the mixture. For simplicity, microfluidic devices discussed here are hereinafter referred to as, traps”. In addition, the mixture released from the trap chamber flows out through a significantly widened section of the main channel. This allows for the continuous fluid to flow around the droplet being released, and consequently, for a low efficiency of pushing out the mixture from the trap. Slowing down the outflow of the mixture is unsuitable as far as the system throughput and the risk of merging the mixture with subsequent droplet flowing into the trap are concerned. In special case, a droplet just outgoing from the trap can be catch up by the next droplet in sequence. For this device, the size of the outgoing droplet depends not only on the geometry, but also on the frequency of the droplets incoming in a sequence. In addition, the traps presented in the references cited above are not symmetric with respect to the change of the direction of flow through the main channel. Such a design prevents from using a trap so constructed in integrated microfluidic chips employing flow reversal in the protocol of operations on microdroplets. All the above limitations are eliminated in a trap designed according to present invention.

Another report [Zagnoni et al., Lab on a Chip, 10, 2010, 3069] describes a device comprising a chamber with bypasses facilitating continuous phase flow and hindering the flow of microdroplets. The bypasses comprise side intrusions in the lumen of the channel, and extend down to the full depth of the main channel. The device stops a queue of N microdroplets in the chamber. Only after the N+1 droplet arrives to the chamber, the first droplet in the queue is being released from the chamber. So, the number of droplets in the chamber remains constant. The trap does not allow for stopping only a single droplet (the trap stops the entire queue of droplets adjoining to each other). A disadvantage of this solution is that it requires the droplets to touch to each other, which may be undesirable in many applications. In addition, the design cited above requires that the entire chamber is filled with droplets. Like in the previous case, the design is not symmetric with respect to the change of the direction of flow through the main channel. Such a design prevents from using a trap so constructed in integrated microfluidic chips employing flow reversal in the protocol of operations on microdroplets. The present patent application discloses solution that eliminates these problems by introducing a bypass running in parallel to the chamber with a single, appropriately shaped inlet and with a single, appropriately shaped outlet at the entrance and the exit of the chamber, respectively.

The paper by Niu et al. [Niu et al., Nature Chemistry, 3, 2011, 437] reports on a device comprising a chamber trapping a droplet of predetermined volume. The chamber comprises a bypass with a number of inlets formed by short sections of microchannels of a depth identical with that of the main channel, and a width smaller than the main channel. The chamber comprises also an outlet of a depth identical with that of the main channel and the chamber, and a width smaller than the main channel and similar to the width of inlets to the bypass. The device allows for titration of solution contained in a droplet by adding subsequent droplets (of a volume smaller than that of the droplet in the trap) to the droplet locked in the trap. After merging, a portion of the droplet locked in the trap is pushed out through the outlet of the chamber into the main channel, and a portion of fluid is detached from it. Sequential addition of droplets with concentration of analytes different than the initial concentration of these analytes in the droplet locked inside the trap allows for releasing droplets with varying concentration of said analytes. A disadvantage of the solution cited above is that it does not determine precisely the volume of the droplet locked in the trap. Because of the shape of the chamber, the shape and volume of the droplet locked therein may essentially depend on the flow rate of the continuous phase and its viscosity. The cited solution does not allow for titration of a trapped droplet with droplets of a wide volume range. In addition, the design cited here is not symmetric with respect to the change of the direction of flow through the main channel. Such a design prevents from using a trap so constructed in the integrated microfluidic chips employing flow reversal in the protocol of operations on microdroplets. The present patent application discloses solution that eliminates these problems by introducing a bypass running in parallel to the chamber with an appropriately shaped connection between the bypass and the main channel, for example in the form of a narrow gap between the “ceiling” (i.e., the upper internal surface) of the main channel and the “floor” (i.e., the lower internal surface) of the bypass. The design disclosed in the present application allows for introducing at the entrance, at the exit, or both at the entrance and at the exit, of a narrowing of the lumen of the main channel in the form of a barrier of a height equal to the height of the walls under the bypass slit.

[Bai et al., Lab on a Chip, 10, 2010, 1281] report on trap chambers forming an array of traps in a wide channel. A lumen of the channel is left between the traps to allow for the flow of both the continuous phase and the droplets. Each trap is made of walls forming a chamber that is open from one side only. Additionally, the walls of the chamber comprise narrow gaps allowing for flow of the continuous phase through the trap. Flow reversal allows for washing out the droplets from the traps and guiding them to other traps. Appropriate flow handling allows for locking two different droplets in a trap. Similar solution has been also reported by [Xu et al., Lab on a Chip, 12, 2012, 725]. A disadvantage of these solutions is that the droplets can flow around the traps and are trapped only by chance. This makes impossible to track the droplets precisely and to identify them by assigning them to a given, strictly specified trap. In solutions disclosed in the present application, the droplets flow through channels that pass through the traps. The droplets flowing through the channel enter the trap in a predetermined sequence which enables unambiguous droplet identification. In addition, such traps can be used to construct a device that generates an array of trapped droplets and allows for controlling of the content of each single droplet in time.

The papers [Du et al., Lab Chip, 9, 2009, 2286-2292; Li et al., J. Am. Chem. Soc., 132, 2010, 112-119; Li et al., Langmuir, 26, 2010, 12465-12471; Pompano et al., Langmuir, 28, 2012, 1931-1941] report on solutions comprising geometrical control over the volume of droplets. These solutions prevent from merging droplets of different volumes by pulling channels and chambers containing the droplets on each other. A disadvantage of the solution is that components of a microfluidic chip must be shifted against each other, which leads to problems with keeping the chip tight and introduces additional mechanical requirements. The solutions according to the present invention eliminate these problems, while enabling similar operations on fluid microdroplets. [Tan et al., Lab on a Chip, 4, 2004, 292; Tan et al., Microlfuid. Nanofluid., 3, 2007, 495; Liu et al., Microfluid. Nanofluid., 3, 2007, 239-243; Bremond et al., PRL 100, 2008, 024501] report on a component of microfluidic system comprising a channel section significantly wider than the width of the inlet and the outlet channel. Such a design results in slowing down the flow in the widened part and in approaching subsequent droplets to each other in the direction of flow, allowing for merging the droplets. A disadvantage of the solution is a limited maximum distance between the droplets that are to be merged in a so designed system. In particular, such a system does not stop a droplet so that it could wait for an arbitrarily long time until another droplet to be merged with the stopped one arrives. The solution according to the present invention allows for stopping droplets that are shorter than the trap length for any arbitrarily selected time period, and allows for merging droplets spaced by any distance. In addition, the solution according to the present invention allows for determining the volume range of droplets to be merged.

The solutions [Ahn et al., Lab Chip, 11, 2011, 3956; Lee et al., Microfluid. Nanofluid., 11, 2011, 685-693] present devices comprising two parallel channels interconnected by cross channels spaced at equal distances. After travelling a certain distance, droplets moving in parallel channels synchronise with each other, i.e., they form droplet pairs moving with the same speed one under the other, even if they were introduced into the system at different times. This solution allows for merging droplets from two unsynchronised droplet generators. A disadvantage of these solutions is that they are geometrically complex and do not allow for stopping a droplet for an arbitrarily long time in order to merge it with another droplet. The devices according to the present invention eliminate these problems by offering the same, and even broader range of operations on microdroplets.

The solution presented by [Takinoue et al., Small, 6, 2010, 2374-2377] allows for stopping a droplet of a well-defined volume in a chamber formed by a blind channel section departing from the main channel. This solution allows also for titration of solution contained in a locked droplet by adding smaller droplets that are merged with the trapped droplet by applying an oscillating electric field. After merging, a portion of the droplet locked in the trap is pushed into the main channel and releases a droplet of a volume similar to that added earlier to the trapped droplet. A drawback of this solution is that it is difficult to precisely control the fluid exchange in the trapped droplet. Because the location, at which the droplet is merged with a fresh droplet arriving through the main channel, is geometrically close to that one, where, after the merging referred to above, a droplet for the main channel is formed, the solutions added to and taken from the locked droplet can be mixed in a poorly controlled way. The solution according to the present invention eliminates the problem by allowing for any shape of the chamber and for any location of inlet and outlet channels. In particular, it is preferable to geometrically separate the locations at which the droplets merge with and detach from the droplet locked in the trap.

[Dangla et al., PRL 107, 2011, 124501] reported a mechanism of droplet anchoring in a microchannel. In the channel of a width much greater that the height they made a well of an area insignificant as compared with the “floor” surface area of the main channel. A portion of a droplet flowing through the channel squeezes in the hole, thus creating a capillary energy barrier, which locks the droplet. Unfortunately, the solution does not allow for precise operations on droplets, in particular, it is not possible to precisely control the volume of a so locked droplet.

[Sun et al., Lab Chip, 11, 2011, 3949] presented a system comprising an array of traps interconnected with a main channel. Each trap has a form of a circle with a diameter greater than the width of the main channel. The trap entrance is wide (as the width of the main channel), and the trap outlet is narrow. Such design allows the continuous phase to flow through the trap and the droplet to flow into the trap. The trap can also be circumvented through a bypass, which has the same cross-sectional size as the main channel. When a large drop moves through the system, droplets formed by the detachment of the volume portions of the large drop get locked in the circular traps. When a droplet containing another analyte is introduced into the system containing locked droplets, then as the droplet moves through the system, the analyte is mixed with droplets in traps in a concentration that is different for each trap. A disadvantage of the solution is that the droplet passing through the trap must be larger than the droplet in the trap. This imposes a limitation for the range of droplet sizes that can be handled with the trap. The solution according to the present invention does not have this disadvantage, and allows for merging droplets locked in traps with droplets of any volume (both larger and smaller than the chamber volume).

Another limitation of the solution [Sun et al., Lab Chip, 11, 2011, 3949] is complexity of the mechanism of material exchange (fluids/solutions) between moving droplet and droplets locked in traps. The exchange of analytes between the moving drop and the droplets locked in traps can take place by convection (laminar and turbulent whirls) and by diffusion. Due to complexity of the process and the dependence of the rate of the exchange of mass on the flow rate, the viscosity of fluids and the diffusion constants of analytes, it is difficult to precisely control the extent of the exchange of mass between the droplets. This difficulty results in the lack of precise control over the analyte concentrations in droplets locked in traps. In the solution according to the present invention, a droplet merging with the droplet locked in the trap fuses entirely with the locked droplet, and the exchange of mass is precisely determined. Moreover, the solution [Sun et al., Lab Chip, 11, 2011, 3949] uses a channel geometry that is not symmetric with respect to the change of the direction of flow of the liquid. Devices according to the present invention allow for designing both the microfluidic systems dedicated to transporting fluids in one direction only, and the systems allowing for conducting complicated protocols of operations on droplets with reversed direction of flow. In particular, the traps according to the present invention allow for precise metering of a predetermined volume of liquid, and subsequently, for washing away that volume of liquid to subsequent traps, where the fluids are merged and mixed in strictly predetermined proportions.

[Takahashi et al., Microfluid. Nanofluid., 9, 2010, 945-953] reported microfluidic device comprising a capillary trap that stops droplets and passes the continuous liquid through a narrow gap placed in the side plane of the main channel. The trap is composed of two neighbouring and adjoining channels, one of which being shallower than another. Both channels are blind at one terminus. The device allows for stopping, colliding and merging droplets in a trap. It does not allow for controlled pushing of merged droplets further to perform subsequent operations on the resulting mixture.

Therefore, the objective of the present invention is to provide microfluidic devices allowing for a broad range of operations on microdroplets in a highly precise manner, free from disadvantages and limitations referred to above. Another objective of the present invention is to provide microfluidic devices that enable to carry out processes and experiments on microdroplets, with the use of such microfluidic devices.

According to a first aspect, there is provided a microfluidic device (100) comprising a microfluidic channel (1) comprising an inlet (2) and an outlet (3), and configured to allow liquid to flow therebetween along a direction of flow, the microfluidic channel (1) comprising at least one obstruction (4a, 4b) extending thereacross such that the transverse dimension of the microfluidic channel (1), as measured in a direction perpendicular to the direction of flow, is less than the transverse dimension of the microfluidic channel (1) at a point spaced apart from the obstruction (4a, 4b), the device (100) further comprising at least one side channel (5) comprising an inlet (7) and an outlet (8), and configured to allow liquid to flow therebetween, the side channel (5) being connected to the microfluidic channel by its inlet (7) and outlet (8), such that its outlet (8) coincides with the obstruction (4a, 4b), and wherein the lumen of the inlet (7) and the outlet (8) of the side channel (5) is less than the lumen of the side channel (5) at a position between its inlet (7) and outlet (8).

Advantageously, and preferably, the geometries of the microfluidic device of the first aspect enables (i) trapping a droplet in a fixed position, (ii) dispensing predetermined droplet volume from a larger volume delivered to a channel, (iii) merging two or more microdroplets flowing in a channel, and/or (iv) changing distances between droplets flowing in a channel.

The transverse dimension of the microfluidic channel (1), as measured in a first direction perpendicular to the direction of flow, may be h₁, and the obstruction (4a) may comprise a barrier (4a) extending across the channel (1), wherein the transverse dimension, h₂, of the microfluidic channel (1), as measured in the first direction perpendicular to the direction of flow, is preferably h₂<h₁. Preferably, 0.1 h₁≦h₂<0.5 h₁, more preferably 0.15 h₁≦h₂<0.4 h₁, most preferably 0.25 h₁≦h₂<0.33 h₁.

FIG. 28 (a) shows schematically an enlarged cross section of a barrier in a first direction perpendicular to the direction of flow, and shows dimensions h₁, and h₂.

The shape of the barrier (4a), as seen when looking in the first direction perpendicular to the direction of flow, may be semicircular or rectilinear.

The width of the barrier (4a), as measured in the direction of flow, can be from 0.25 h₁ to 2 h₁, more preferably from 0.3 h₁ to 1.5 h₁, most preferably from 0.3 h₁ to 0.6 h₁

The microfluidic channel (1) may comprise a second obstruction which may comprise a second barrier (4a) extending across the channel (1), wherein the transverse dimension, h₂₂, of the microfluidic channel (1), as measured in the first direction perpendicular to the direction of flow, may be h₂₂<h₁. The second obstruction is preferably disposed along the microfluidic channel (1) and spaced apart from the first obstruction. Preferably, 0.1 h₁≦h₂₂<0.5 h₁, more preferably 0.15 h₁≦h₂₂<0.4 h₁, most preferably 0.25 h₁≦h₂₂<0.33 h₁.

The shape of the second barrier (4a), as seen when looking in the first direction perpendicular to the direction of flow, may also be semicircular or rectilinear. The width of the second barrier (4a), as measured in the direction of flow, is preferably from 0.25 h₁ to 2 h₁, more preferably from 0.3 h₁ to 1.5 h₁, most preferably from 0.3 h₁ to 0.6 h₁.

The transverse dimension of the microfluidic channel (1), as measured in a second direction perpendicular to the direction of flow, is preferably w₁, and the obstruction (4b) comprises a side intrusion (4b) extending across the channel (1), wherein the transverse dimension, w₂, of the microfluidic channel (1), as measured in the second direction perpendicular to the direction of flow, is w₂<w₁. Preferably, 0.1 w₁≦w₂<0.5 w₁, more preferably 0.15 w₁≦w₂<0.4 w₁, most preferably 0.25 w₁≦w₂<0.33 w₁.

FIG. 28 (b) shows schematically an enlarged cross section of a side intrusion in a second direction perpendicular to the direction of flow, and shows dimensions w₁ and w₂.

The first direction perpendicular to the direction of flow and the second direction perpendicular to the direction of flow are preferably orthogonal to each other.

The microfluidic channel (1) may comprise a second obstruction which may comprise a second side intrusion (4b) extending across the channel (1), wherein the transverse dimension, w₂₂, of the microfluidic channel (1), as measured in the second direction perpendicular to the direction of flow, is preferably w₂₂<w₁. Preferably, 0.1 w₁≦w₂₂<0.5 w₁, more preferably 0.15 w₁≦w₂₂<0.4 w₁, most preferably 0.25 w₁≦w₂₂<0.33 w₁.

FIG. 28 (c) shows schematically an enlarged cross section of side intrusions in a second direction perpendicular to the direction of flow, and shows dimensions w₁ and w₂₂.

The lumen of the inlet (7) of the side channel (5) and the outlet (8) of the side channel (5) is preferably less than the lumen of the side channel (5) at a position between its inlet (7) and outlet (8) by at least 50%, and preferably from 66% to 75%, for example by narrowing or shallowing the inlet (7) and/or outlet (8) of the side channel (5).

The transverse dimension, h₃, of the side channel (5), as measured in the first direction perpendicular to the direction of flow, is h₃≦h₂<h₁. Preferably, 0.1 h₁≦h₃<0.5 h₁, more preferably 0.15 h₁≦h₃<0.4 h₁, most preferably 0.25 h₁≦h₃<0.33 h₁.

The device may comprise a baffle (6) preferably disposed at least partially between the microfluidic channel (1) and the at least one side channel (5). The baffle (6) is preferably disposed at least adjacent the obstruction (4a, 4b) and may extend along 40% to 95%, preferably along 50% to 90%, and more preferably along 70% to 80%, of the length of the side channel (5), as measured in the direction of flow. The baffle (6) is preferably configured to allow liquid flow between the microfluidic channel (1) and inlet (7) and outlet (8) of the side channel (5).

The device (too) may comprise a second side channel (5) comprising an inlet (7) and an outlet (8), and configured to allow liquid to flow therebetween, the second side channel (5) can be connected to the microfluidic channel by its inlet (7) and outlet (8), such that its outlet (8) coincides with the obstruction (4a, 4b), and the lumen of the inlet (7) and the outlet (8) of the second side channel (5) can be less than the lumen of the second side channel (5) at a position between its inlet (7) and outlet (8).

The transverse dimension, h₃₃, of the second side channel (5), as measured in the first direction perpendicular to the direction of flow, may also be h₃₃≦h₂<h₁. Preferably, 0.1 h₁≦h₃₃<0.5 h₁, more preferably 0.15 h₁≦h₃₃<0.4 h₁, most preferably 0.25 h₁≦h₃₃<0.33 h₁.

The device may comprise a second baffle (6) disposed at least partially between the microfluidic channel (1) and the second side channel (5).

The two side channels (5) may be positioned symmetrically with respect to the microfluidic channel (1), preferably either side thereof.

The microfluidic channel (1) and/or the at least one side channel may have a square, rectangular or circular cross-section in the plane perpendicular to the direction of flow.

The device may comprise first and second obstructions extending across the microfluidic channel (1), wherein the first obstruction can be either a barrier or a side intrusion, and the second obstruction is preferably the other of the barrier or the side intrusion.

The microfluidic device (100) may comprise at least one valve disposed in the microfluidic channel (1) downstream of the obstruction.

The liquid may comprise a droplet transported by a continuous phase. The droplet is preferably immiscible with the continuous phase. The droplet may comprise chemical, biochemical or biological entities, cells, particles, gases, molecules, DNA, RNA, proteins, or lipids dissolved or suspended therein. The continuous phase may comprise oil, for example silicone oil, mineral oil, a fluorocarbon oil or a hydrocarbon oil), or an aqueous solution, for example water or water containing one or more other species that are dissolved or suspended therein, for example a salt solution or a saline solution.

The microfluidic channel (1) of the device may create a loop preferably comprising a first T-junction leading to first and second channels which are configured to allow liquid flow, the first and second channels preferably leading to a second T-junction, wherein preferably the transverse dimension of the first channel at least adjacent the first T-junction, as measured in a direction perpendicular to the direction of flow, is greater than the transverse dimension of the second channel at least adjacent the first T-junction, and wherein preferably the transverse dimension of the first channel at least adjacent the second T-junction, is less than the transverse dimension of the second channel at least adjacent the second T-junction.

The transverse dimension of the first channel at least adjacent the first T-junction, as measured in a direction perpendicular to the direction of flow, is preferably greater than the transverse dimension of the first channel at least adjacent the second T-junction, and wherein the transverse dimension of the second channel at least adjacent the first T-junction, is preferably less than the transverse dimension of the second channel at least adjacent the second T-junction.

The transverse dimension of the first and/or second channel remains substantially constant for at least half of its length. Preferably the change in transverse dimension of the first and/or second channel is gradual between the first and second T-junctions.

The transverse dimension of the first and second channels may be measured in a first direction perpendicular to the direction of flow, h₄, and/or in a second direction perpendicular to the direction of flow, w₄. The ratio between the transverse dimension of the first and second channels at least adjacent the first and/or second T-junction may be ≦1:100, ≦1:50, ≦1:25, ≦1:10 or ≦1:5.

In a second aspect, the invention provides a microfluidic channel in the form of a loop comprising a first T-junction leading to first and second channels which are configured to allow liquid flow, the first and second channels leading to a second T-junction, wherein the transverse dimension of the first channel at least adjacent the first T-junction, as measured in a direction perpendicular to the direction of flow, is greater than the transverse dimension of the second channel at least adjacent the first T-junction, and wherein the transverse dimension of the first channel at least adjacent the second T-junction, is less than the transverse dimension of the second channel at least adjacent the second T-junction.

The transverse dimension of the first and second channels may be as defined above.

According to a third aspect of the invention, there is provided a microfluidic system comprising one or more microfluidic devices according to the first aspect.

These one or more microfluidic devices may be configured to allow fluid to flow either unidirectionally or bidirectionally. The system may comprise means for mixing droplets. The mixing means is preferably in the form of a channel section with a larger lumen, a channel section with a varying channel lumen, or in the form of a meandering section of the microfluidic channel.

According to a fourth aspect of the invention, there is provided a polymerase chain reaction (PCR) apparatus comprising a microfluidic device according to the first aspect, or a microfluidic system according to the third aspect of the invention.

In a fifth aspect, there is provided a method for performing an operation on a microfluidic droplet, the method comprising flowing a microfluidic droplet, in a continuous phase, through a microfluidic device according to the first aspect, or the system according to the third aspect.

In a sixth aspect of the invention, there is provided use of the microfluidic device according to the first aspect, or the system according to the third aspect, for manipulating a microfluidic droplet.

The methods and uses of the fifth and sixth aspects enable complex hydraulic operations on sample volumes to be performed. For example, in one embodiment, the integration of a plurality of microfluidic devices according to the invention allows for the generation of a sequence of sample dilutions (for example with a buffer) to yield sample concentrations decreasing in geometric series in consecutive droplets. In another embodiment, the integration of devices according to the invention allows for the generation of a sequence of droplets with a predetermined dilution profile and for confinement of these droplets in strictly defined locations in a microfluidic cartridge comprising the microfluidic devices. Advantageously, the devices and systems according to the invention can be effectively used for the assessment of the results of chemical and biochemical reactions performed on small samples of solutions or body fluids. The systems according to the invention can also be used to perform time- and cost-effective microbiological studies, for example PCR.

According to a further aspect, there is provided a microfluidic device, comprising a microfluidic channel, having an inlet and an outlet, and allowing for flow of liquid in the direction of flow, i.e., along a straight line running from the inlet to the outlet of the microfluidic channel, the transverse dimension of which, as measured in the first direction perpendicular to the direction of flow, is h₁, and the transverse dimension of which, as measured in the second direction perpendicular to the direction of flow, is w₁, characterised in that the microfluidic channel comprises an obstruction in the form of
a barrier, i.e., an area, where the transverse dimension h₂ of the microfluidic channel, as measured in the first direction perpendicular to the direction of flow, is h₂<h₁; or
a side intrusion, i.e., an area, where the transverse dimension w₂ of the microfluidic channel, as measured in the second direction perpendicular to the direction of flow, is w₂<w₁,
   and that the device comprises minimum one side channel, connected with the microfluidic channel through the inlet of the side channel and the outlet of the side channel, and connected with the obstruction, whereas the lumen of the inlet of the side channel and the outlet of the side channel is reduced as compared with the lumen of the side channel at a place located between its inlet and outlet, preferably by minimum 50%, and more preferably from 66% to 75%, in particular by narrowing or shallowing the side channel in the inlet and the outlet areas of the side channel.

Preferably, the transverse dimension h₃ of the side channel, as measured in the first direction perpendicular to the direction of flow, is h₃≦h₂<h₁.

Preferably, 0.1 h₁≦h₃<0.5 h₁, more preferably, 0.15 h₁≦h₃<0.4 h₁, most preferably 0.25 h₁≦h₃<0.33 h₁.

Preferably, the side channel is in part separated from the microfluidic channel by a baffle not allowing for the flow of fluid, whereas the baffle starts near the obstruction and comprises from 40% to 95% of the length of the side channel, as measured in the direction of flow, more preferably from 50% to 90% of the length of the side channel, as measured in the direction of flow, and most preferably from 70% to 80% of the length of the side channel, as measured in the direction of flow.

Preferably, the device comprises additionally a second side channel, connected with the microfluidic channel through the inlet of the side channel and the outlet of the side channel, and connected with the obstruction, whereas the lumen of the inlet of the second side channel and the outlet of the second side channel is reduced as compared with the lumen of the second side channel at a place located between its inlet and outlet, preferably by minimum 50%, and more preferably by 66% to 75%, in particular by narrowing or shallowing the second side channel in the inlet and the outlet areas of the second side channel.

Preferably, the transverse dimension h₃₃ of the second side channel, as measured in the first direction perpendicular to the direction of flow, is h₃₃≦h₂<h₁.

Preferably, 0.1 h₁≦h₃₃<0.5 h₁, more preferably, 0.15 h₁≦h₃₃<0.4 h₁, most preferably 0.25 h₁≦h₃₃<0.33 h₁.

Preferably, the second side channel is in part separated from the microfluidic channel by a baffle not allowing for the flow of fluid, whereas the baffle starts near the obstruction and comprises from 40% to 95% of the length of the second side channel, as measured in the direction of flow, more preferably from 50% to 90% of the length of the second side channel, as measured in the direction of flow, and most preferably from 70% to 80% of the length of the second side channel, as measured in the direction of flow.

Particularly preferably, the two side channels are positioned symmetrically with respect to the microfluidic channel.

Preferably, the microfluidic channel and possibly the side channel or channels have a square, rectangular or circular cross-section in the plane perpendicular to the direction of flow.

Preferably, the microfluidic channel comprises an obstruction in the form of a barrier.

Preferably, 0.1 h₁≦h₂<0.5 h₁, more preferably, 0.15 h₁≦h₂<0.4 h₁, most preferably 0.25 h₁≦h₂<0.33 h₁.

Preferably, the shape of the barrier, as seen when looking in the first direction perpendicular to the direction of flow, is semicircular or rectilinear.

Preferably, the width of the barrier, as measured in the direction of flow, is from 0.25 h₁ to 2 h₁, more preferably from 0.3 h₁ to 1.5 h₁, most preferably from 0.3 h₁ to 0.6 h₁

Preferably, the microfluidic channel comprises additionally a second obstruction in the form of a second barrier, i.e., an area, where the transverse dimension h₂₂ of the microfluidic channel, as measured in the first direction perpendicular to the direction of flow, is h₂₂<h₁.

Preferably, 0.1 h₁≦h₂₂<0.5 h₁, more preferably, 0.15 h₁≦h₂₉<0.4 h₁, most preferably 0.25 h₁≦h₂₂<0.33 h₁.

Preferably, the shape of the second barrier, as seen when looking in the first direction perpendicular to the direction of flow, is semicircular or rectilinear.

Preferably, the width of the second barrier, as measured in the direction of flow, is from 0.25 h₁ to 2 h₁, more preferably from 0.3 h₁ to 1.5 h₁, most preferably from 0.3 h₁ to 0.6 h₁.

Preferably, the microfluidic channel comprises an obstruction in the form of a side intrusion.

Preferably, 0.1 w₁≦w₂<0.5 w₁, more preferably, 0.15 w₁≦w₂<0.4 w₁, most preferably 0.25 w₁≦w₂<0.33 w₁.

Preferably, the microfluidic channel additionally comprises a second obstruction in the form of a second side intrusion, i.e., an area, where the transverse dimension w₂₂ of the microfluidic channel, as measured in the first direction perpendicular to the direction of flow, is w₂₂<w₁.

Preferably, 0.1 w₁≦w₂<0.5 w₁, more preferably, 0.15 w₁≦w₂₂<0.4 w₁, most preferably 0.25 w₁≦w₂₂<0.33 w₁.

The invention also relates to a microfluidic system, comprising one or more such microfluidic devices.

Preferably, the system according to the invention comprises additionally an element or elements for mixing droplets, preferably in the form of a channel section with a larger lumen, a channel section with a varying channel lumen, or in the form of a meandering section of the microfluidic channel.

Hereinafter, the microfluidic devices according to the present invention are simply referred to as “traps”.

All of the features described herein (including any accompanying claims, abstract and drawings), and/or all of the steps of any method or process so disclosed, may be combined with any of the above aspects in any combination, except combinations where at least some of such features and/or steps are mutually exclusive.

For a better understanding of the invention, and to show how embodiments of the same may be carried into effect, reference will now be made, by way of example, to the accompanying diagrammatic drawing, in which:—

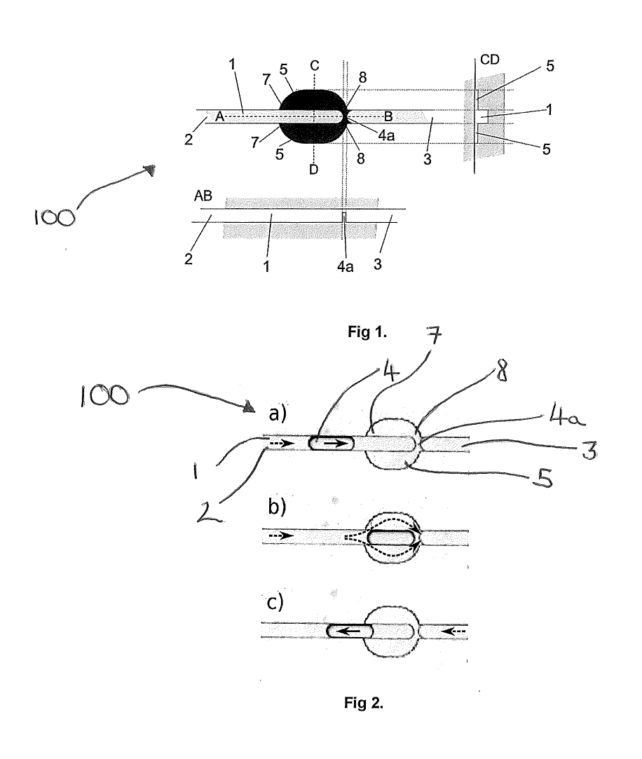

FIG. 1 shows schematically a metering trap in a directional version with one Barrier;

FIG. 2 illustrates in micrographs the operation of the trap from FIG. 1 in the case it is filled with continuous liquid, and a droplet of a volume equal to or smaller than the trap volume enters the trap;

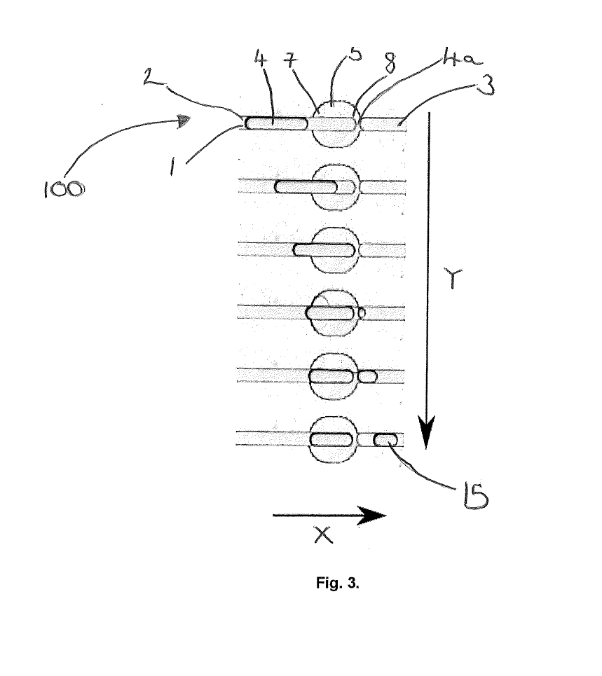

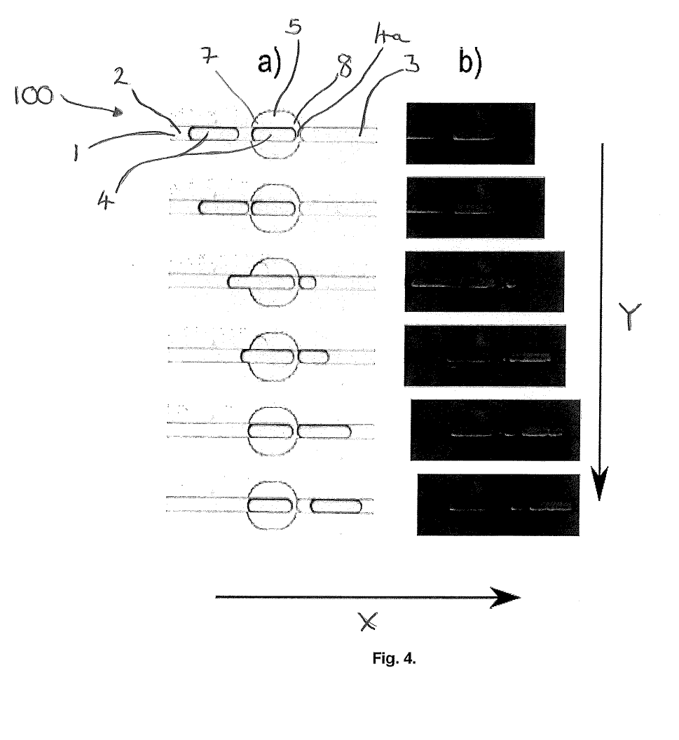

FIG. 3 shows a sequence of micrographs illustrating a situation when a droplet flowing (forward) into a unidirectional metering trap from FIG. 1 has a volume larger than the volume of the trap;

FIG. 4 shows a sequence of micrographs illustrating a situation when a second droplet arrives at the trap from FIG. 1, wherein the first droplet is already present, whereas the two droplets (a) merge, or (b) do not merge;

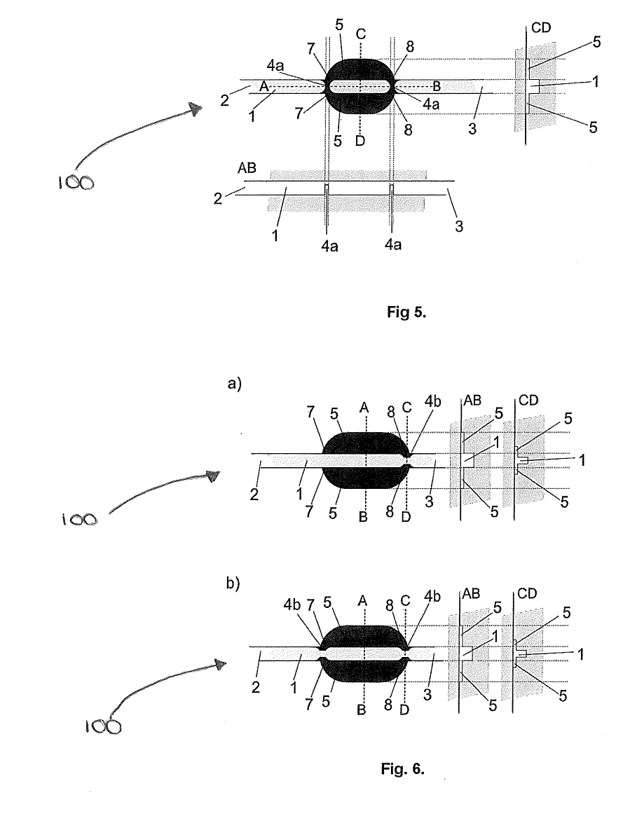

FIG. 5 shows schematically a metering trap in a bidirectional version with two Barriers;

FIG. 6 shows schematically a merging trap in directional version with one side intrusion (a), and in symmetric version with two side intrusions (b) (Example 2);

FIG. 7 shows a sequence of micrographs illustrating the passing of droplets through a bidirectional merging trap from FIG. 6b;

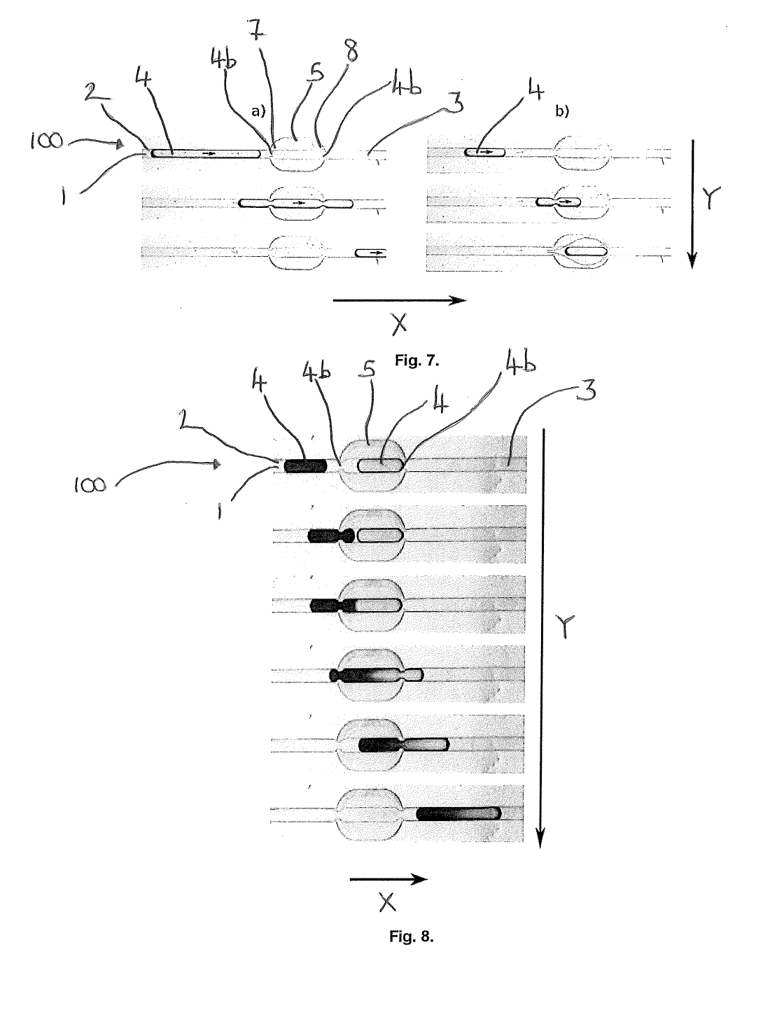

FIG. 8 shows a sequence of micrographs illustrating the merging in a merging trap from FIG. 6b;

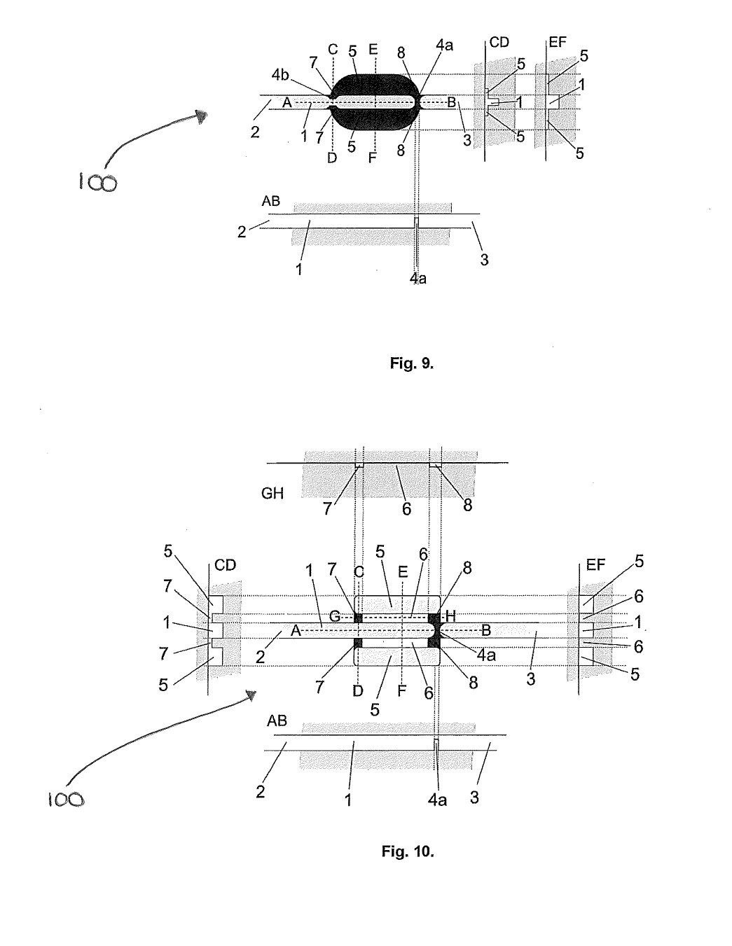

FIG. 9 shows schematically a metering-merging trap (Example 3);

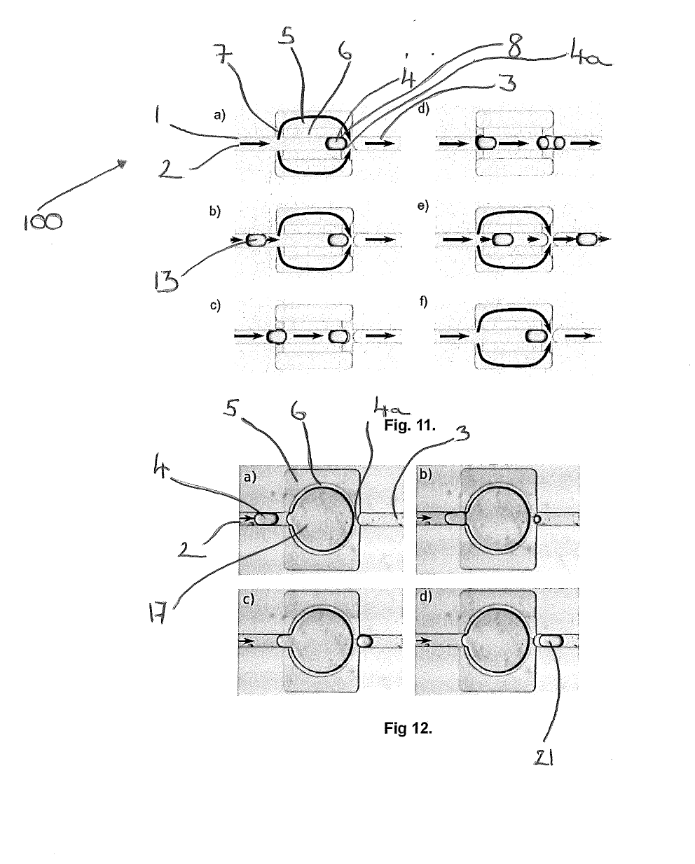

FIG. 10 shows schematically the trap with additional baffles (“lock&shift trap” Example 4);

FIG. 11 shows a sequence of micrographs illustrating operation of the lock&shift trap (Example 4);

FIG. 12 shows a sequence of micrographs illustrating operation of the circular trap (Example 4);

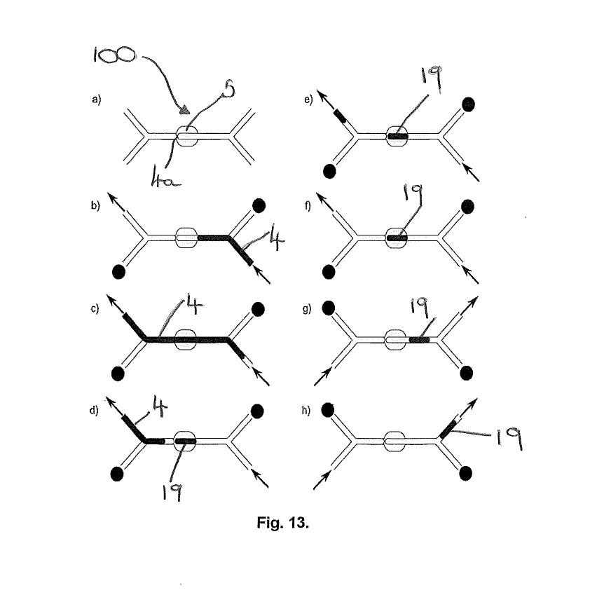

FIG. 13 illustrates schematically generation of droplets of a predetermined size by reversing the flow in the trap (Example 5);

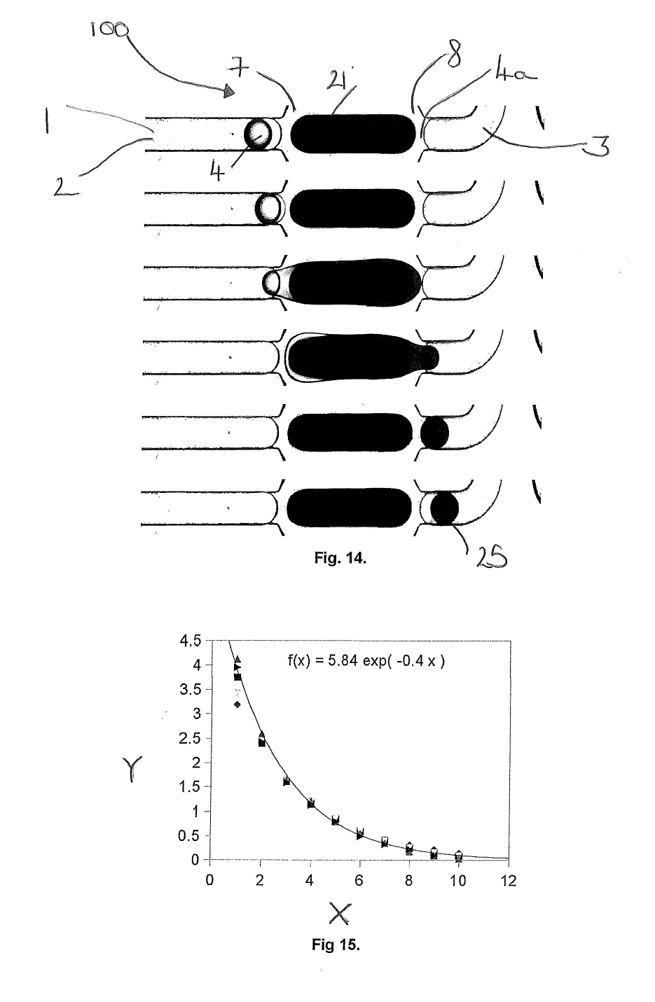

FIG. 14 shows a typical system according to the invention —a dilutor (Example 6);

FIG. 15 shows concentration in subsequent droplets released by the dilutor (Example 6);

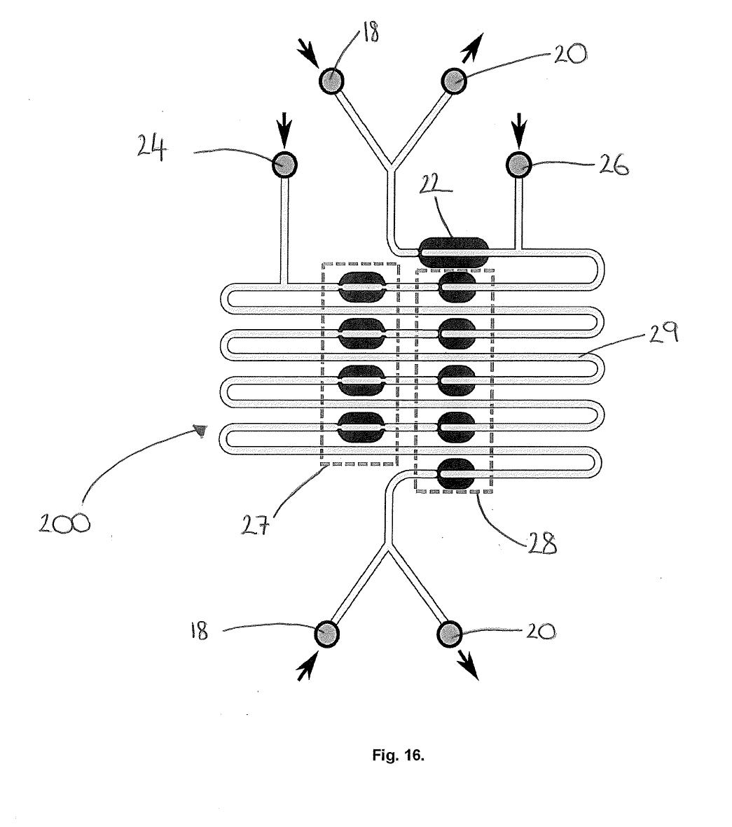

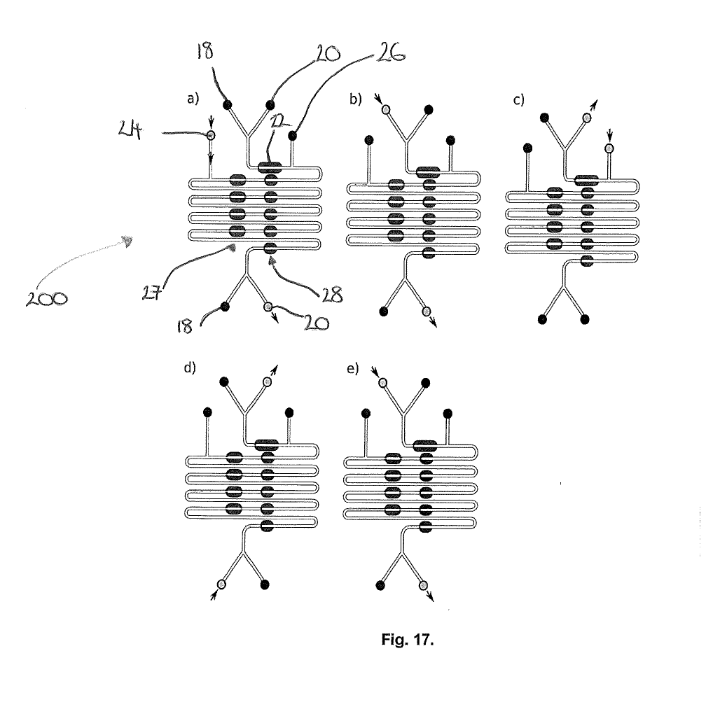

FIG. 16 shows a scheme of the DOMINO system (Example 7);

FIG. 17 shows schematically the control of operation of the DOMINO system (Example 7);

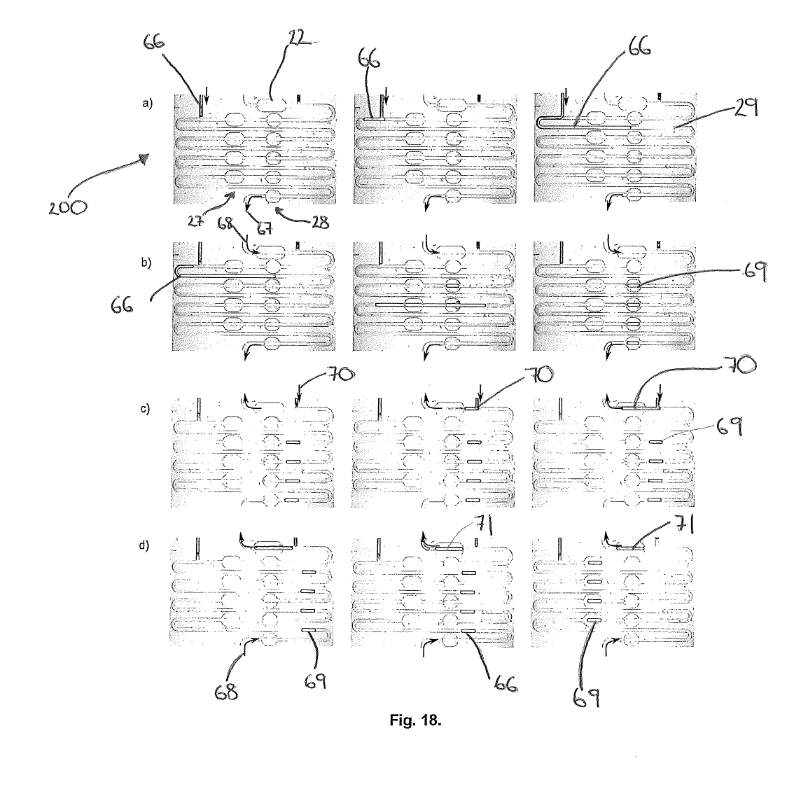

FIG. 18 shows images illustrating the operation of the DOMINO system in phases a)-d) shown in FIG. 17 (Example 7);

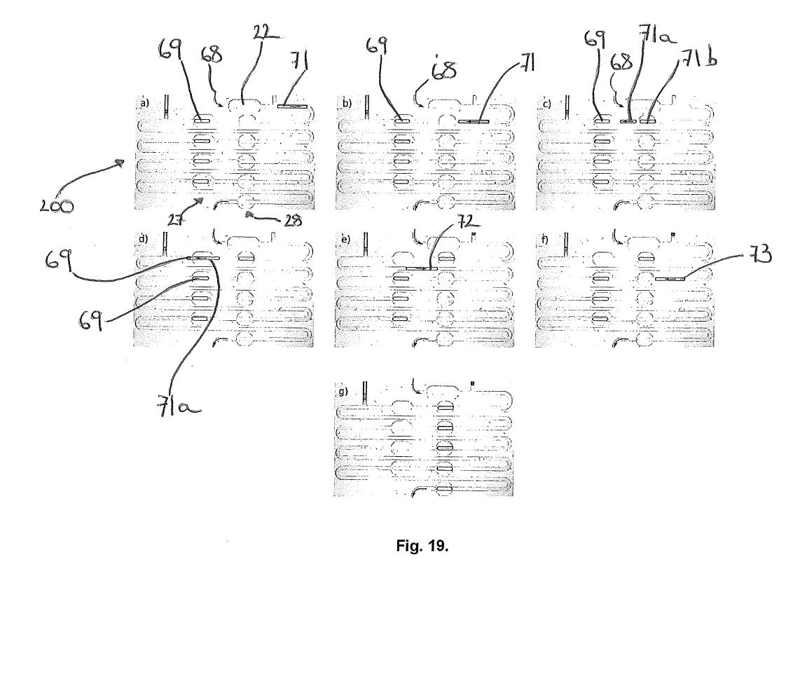

FIG. 19 shows images illustrating the mechanism of generation of serial dilutions (Example 7);

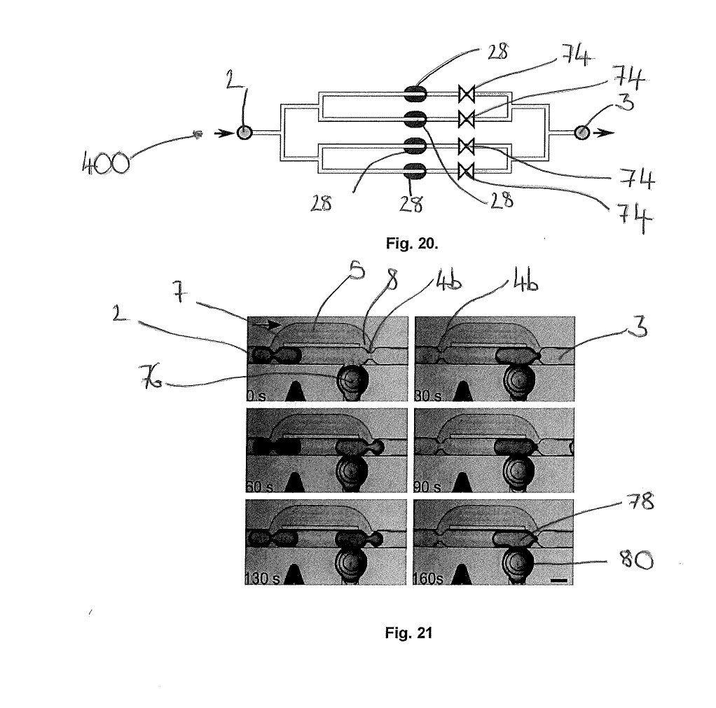

FIG. 20 shows schematically a typical system according to the invention—a trapostat (Example 8);

FIG. 21 shows a collection of micrographs showing a process conducted in a trap with a baffle and with one bypass, as described in Example 9;

FIG. 22 shows a schematic representation of a) a classic microfluidic loop and b) a loop with a derailer (shading indicates the change in height of the loop);

FIG. 23 shows a collection of micrographs showing the transport of droplets in a classic loop (top) and a loop with a derailer (bottom). White arrows indicate the direction of flow and black arrows indicate the direction of the droplets in the loops;

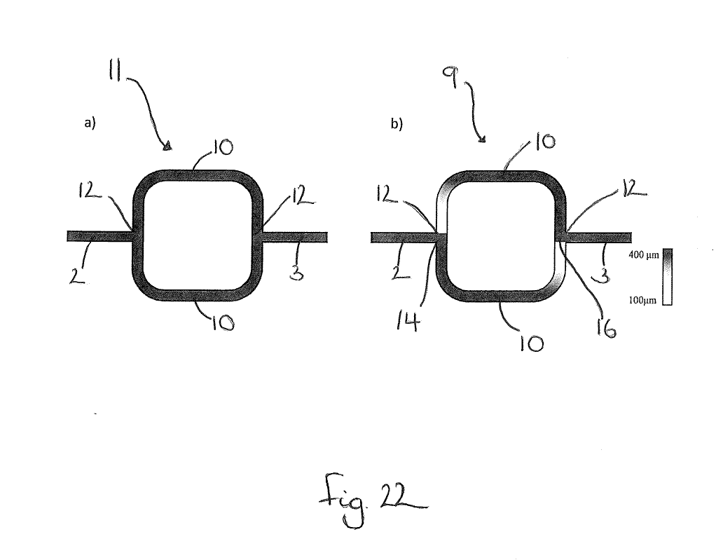

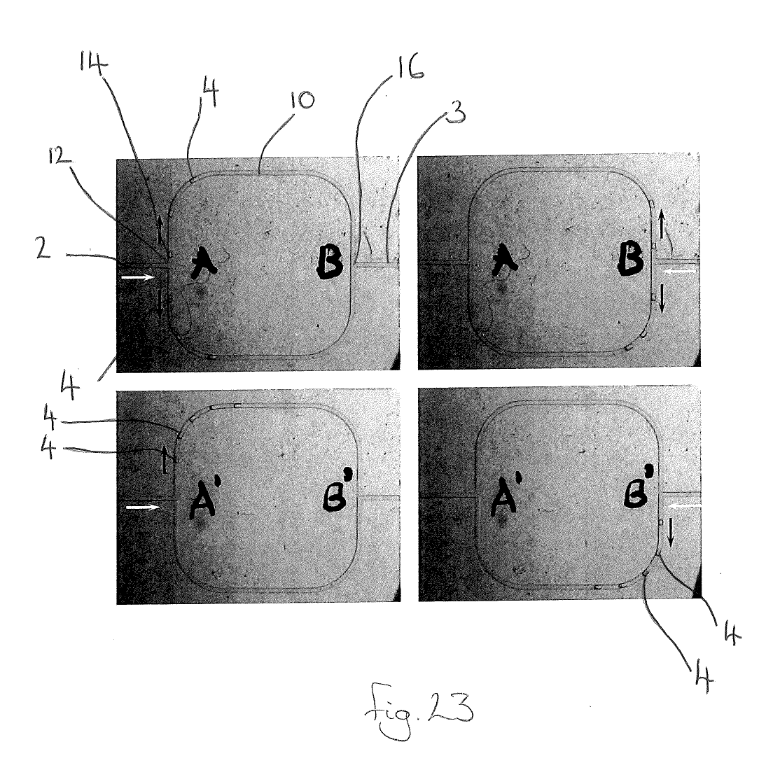

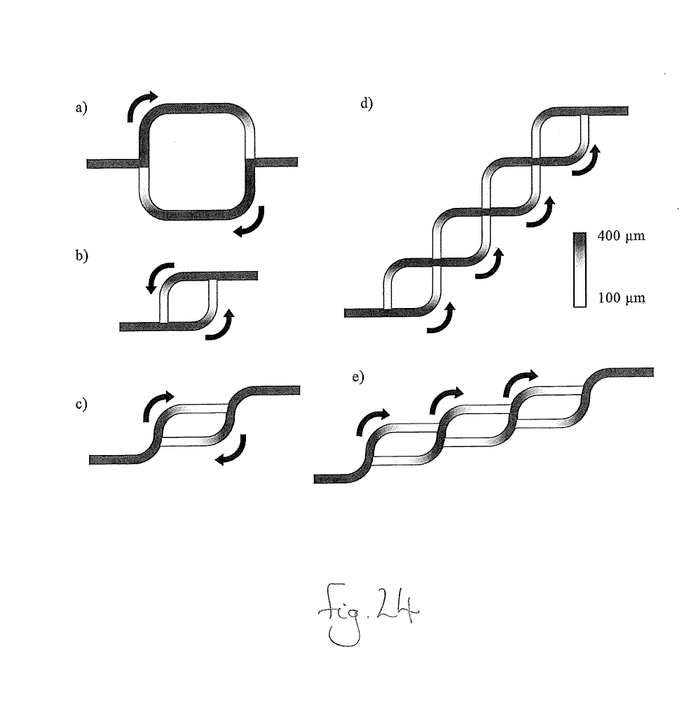

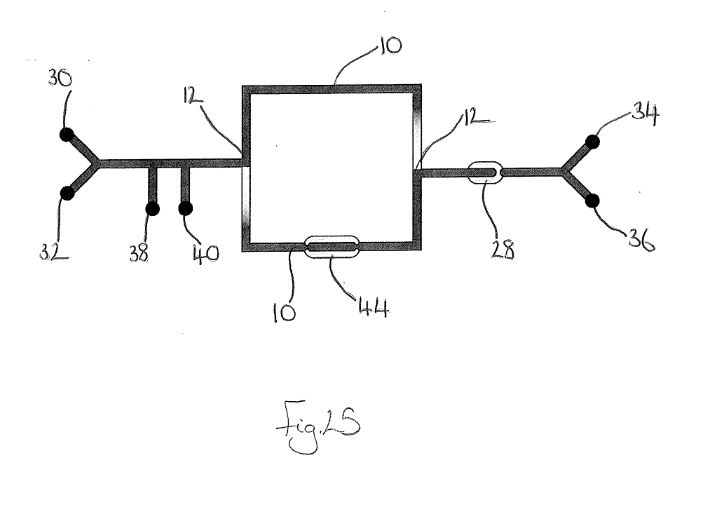

FIG. 24 shows various designs of derailing loops (a) to c)) and networks (d) to e)). Arrows indicate the direction of transport of the droplets in one direction of flow, and in the reverse direction of flow;

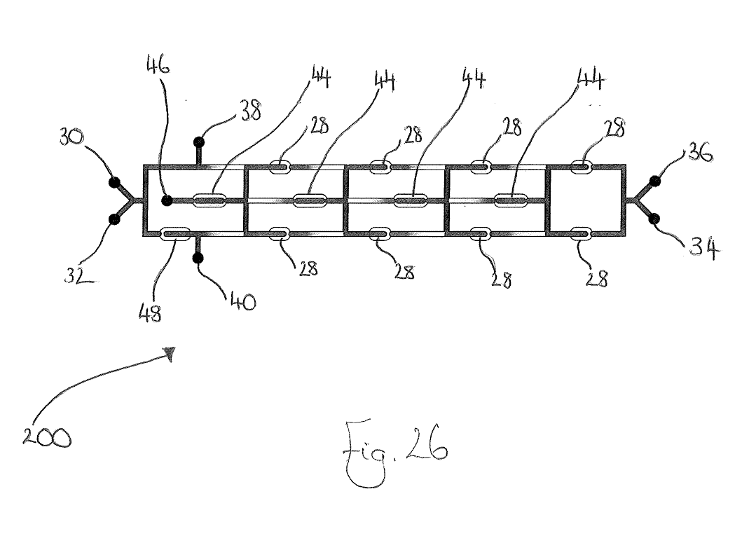

FIG. 25 shows a schematic representation of a single unit of a derailer-metering-merging trap combination. The system can be used for generation of concentration on demand;

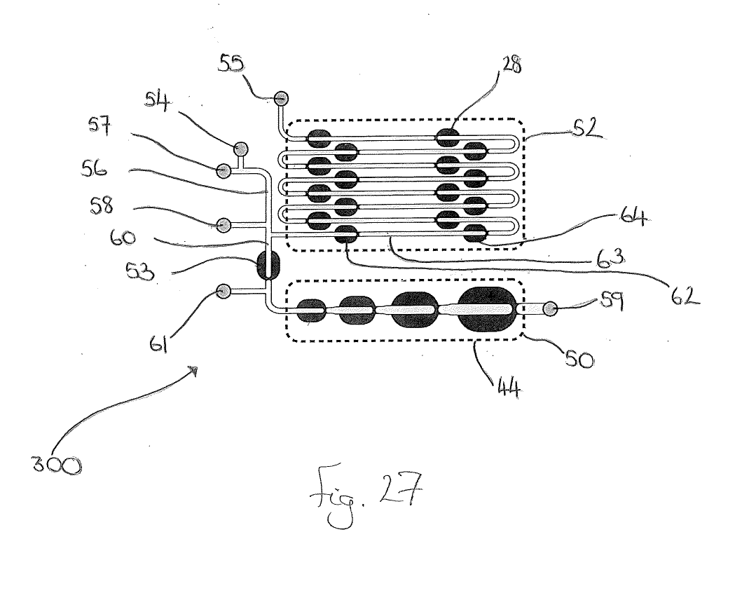

FIG. 26 shows a schematic representation of a MIC system (for simpler illustration it comprises only 4 segments);

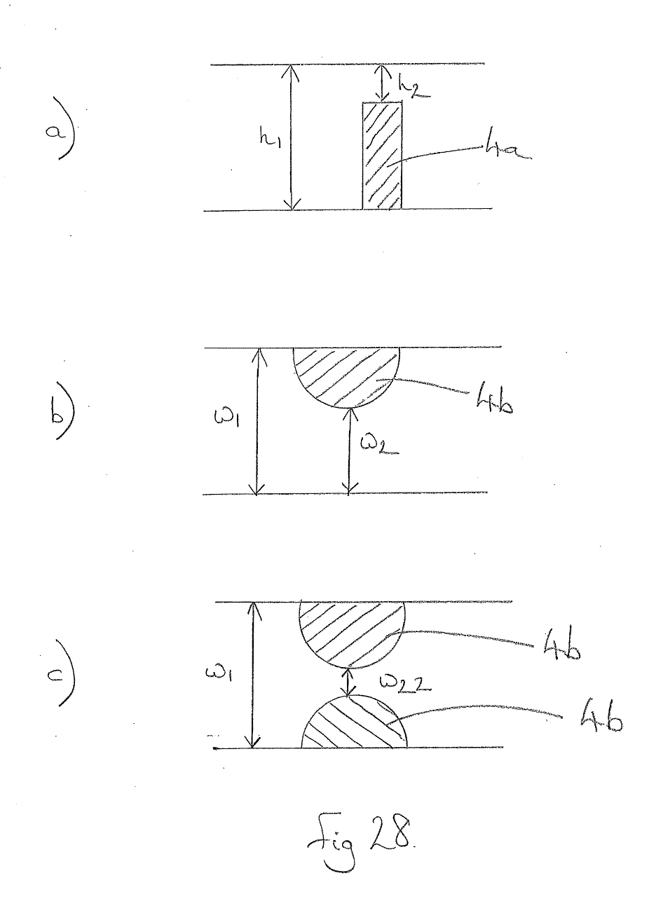

FIG. 27 schematic layout of a microfluidic chip for digital dilution droplet PCR; and

FIG. 28 shows schematically an enlarged cross section of a barrier (a) in a first direction perpendicular to the direction of flow, and showing dimensions h₁ and h₂, and side intrusion/s (b) and (c) in a second direction perpendicular to the direction of flow, and showing dimensions w₁, w₂ and w₂₂.

### EXAMPLES

The invention will now be described by way of illustration only in the following examples.

### Example 1

### Metering Trap

FIG. 1 depicts schematically one of the microfluidic devices 100 according to the invention—a so called metering trap, in a directional version, i.e., with one obstruction.

FIG. 1 shows a metering trap in top view (main drawing) and in sections along the AB line (bottom drawing) and along the CD line (right drawing). In presented embodiment the trap comprises the microfluidic channel 1, having the inlet 2 and the outlet 3, and allowing for the flow of liquid in this channel 1, in the direction from the inlet 2 to the outlet 3, referred to as the direction of flow. The direction of flow shall mean here the straight line, connecting the inlet 2 and the outlet 3. The sense of the flow of the liquid in the microfluidic channel can vary depending on the application, i.e., the liquid can flow from the inlet 2 to the outlet 3 or in the opposite direction—always, however, along the straight line set by the inlet 2, the outlet 3, and the microfluidic channel 1 connecting the inlet 2 with the outlet 3. In particular, hereinafter we use the phrasing “forward flow”, when the sense of the flow is from the inlet 2 to the outlet 3, and the phrasing “backward flow” or “reversed flow”, when the flow is from the outlet 3 to the inlet 2.

In the presented embodiment, the metering trap comprises an obstruction in the form of a barrier 4a, placed in the microfluidic channel 1, and two side channels 5 (bypasses), positioned symmetrically with respect to the microfluidic channel 1 and the barrier (obstruction) 4a. Each side channel is connected with the microfluidic channel 1 through the inlet 7 of the side channel 5 and the outlet 8 of the side channel 5, and connected with the obstruction 4, whereas the lumen of the inlet 7 of the side channel 5 and the outlet 8 of the side channel 5 is reduced as compared with that of the side channel at a place located between its inlet 7 and outlet 8, preferably by minimum 50%, and more preferably from 66% to 75%. “Reduction of the lumen” shall mean the reduction of the surface area of the channel's cross-section. In particular, it can be achieved by narrowing or shallowing of the side channel 5 in the area of inlet 7 and outlet 8 of the side channel. Reduction of the lumen of the bypass 5 at its inlet 7 and outlet 8 to the main channel 1 is necessary for correct trap operation. As a result, there is a barrier preventing the droplet locked in the trap from entering the bypasses. This is a prerequisite for an efficient separation of the flow of the continuous phase through the side channels from the flow of the droplet phase through the main channel.

The microfluidic channel 1 has a square cross-section (i.e., in the plane perpendicular to the direction of flow as defined above), with dimensions 360 μm×360 μm. An obstruction is the barrier 4a, i.e., the section of the microfluidic channel 1, where its depth is 100 μm. The length of the barrier, as measured in the direction of flow, is about 100 μm. The 100 μm deep side channels are connected with the barrier 4a, and also with the microfluidic channel 1, running in parallel to the channel 1, symmetrically on both its sides, on a length from 1 mm to a few millimetres. The shape of the barrier 4a, as seen when looking from above, i.e., in the direction perpendicular to the direction of flow, in which the depth of the channels 1, 5 is measured—is semi-circular. The presented microfluidic device is entirely fabricated from polycarbonate.

### Possible Modifications of the Trap

Those skilled in the art will easily understand that specific dimensions, shapes and geometries of the disclosed metering trap are typical only, and do not exhaust many design possibilities, as long as these are consistent with the present invention. In particular, the cross-section of the microfluidic channel can have transverse dimensions from single micrometers to single millimetres and not necessarily must be square—channels with rectangular or other cross-sections, e.g., oval or circular ones, are possible. The same relates to side channels, whereas their depth can be greater, equal to or smaller than the depth of the microfluidic channel, but preferably it represents not more than 90% of the depth of the microfluidic channel. In a very preferred embodiment there are two side channels, running symmetrically and of identical depth. Asymmetrical embodiments are, however, also possible, e.g., ones comprising two side channels of different depths, each of which meets the conditions mentioned above, two side channels of different lengths and identical or non-identical depth, or comprising one side channel only. Side channel or channels must always terminate or start at the barrier, and more generally at the obstruction. The shape of the obstruction 4a (looking from above) not necessarily must be semicircular—it can be also oval, polygonal, flat or irregular, while symmetrical or asymmetrical at the same time. The length of the barrier (as measured along the direction of flow) can be from 1/10 to several widths of the main channel and is limited by practical considerations only. In particular, small width of the channel can put a limitation on the maximum flow rate of the continuous liquid, at which the device operates correctly, i.e. stops a droplet in the trap. Finally, the plastic the trap is to be fabricated of can be selected from a wide range of plastics used for fabrication of microfluidic devices, whereas such plastics are well known to those skilled in the art. In particular, a trap according to the invention can be fabricated of glass, ceramic materials, metals, or a broad range of polymers, including chemically and thermally hardened materials.

An important, permissible modification of the trap according to the invention relies on the possibility of changing the width and/or depth of the section of the microfluidic channel that adjoins to the side channel. In particular, that section of the microfluidic channel can be wider than the parts of the microfluidic channel, which do not adjoin to the side channel, and additionally, the width can vary (while shifting in the direction of flow). Also the envelope of the side walls of the microfluidic channel, when looking from above, must not be essentially a straight line (as illustrated in FIG. 1), but can be another curve (e.g. a section of a circle or ellipse).

The metering trap shown in FIG. 1 operates so that it stops (traps) droplets moving forward through the trap. The trap has its predetermined volume (hereinafter referred to as the trap volume), equal to the volume of the largest droplet that could be locked in the trap. The volume is somewhat smaller than the volume of the channel between the entrance and the exit of the side channels.

If the trap contains a continuous liquid only, and a droplet of a volume equal to or smaller than the trap volume flows into the trap (during the forward flow), then the droplet is locked in the trap. The process is illustrated in FIG. 2, where in FIG. 2a and FIG. 2b the solid arrow indicates the speed of the droplet flowing into the trap, and the dashed arrows indicate the flow of the continuous liquid. After reversing the flow, the droplet locked earlier in the trap is released from the unidirectional trap (FIG. 2c).

When a droplet 4 flowing (forward) into the unidirectional metering trap has a volume larger than the trap volume, then such droplet 4 flows through the trap until its rear aligns with the entrance to the trap. At that moment, the continuous liquid starts to flow through the side channels 5, the droplet stops to flow forward, and the inflow of the continuous liquid over the barrier 4a results in the detachment of a portion of the droplet that is located behind the barrier 4a (in the direction of flow). As a result, the trap locks a droplet 4 of trap volume, and the excess liquid 15 in the original droplet 4 is released and passes through the trap. FIG. 3 shows a sequence of micrographs illustrating the series of events described above, where x is the direction of flow and y is time.

If a metering trap contains an earlier locked droplet 4 of a volume equal to the trap volume, then, irrespective of the length of the incoming subsequent droplet, the same droplet volume (equal to the trap volume) will remain in the trap, and the volume of the droplet liquid that will be released from the trap will be the same as that which entered the trap. Thus, the passing of a droplet results in a partial or entire replacement of the analyte inside the trap, but does not change its amount. When the length of the droplet is much larger than the length of the trap, the material inside the trap is entirely replaced.

Depending on the analytes, the droplet 4 arriving at the trap can either merge with the droplet 4 that was already locked in the trap, or push out the droplet locked earlier (or a portion thereof) without merging. When the droplets merge, a droplet is obtained at the trap exit that is equally as long as the one which entered the trap (FIG. 4a), where x is the direction of flow and y is time. When the droplets do not merge and the length of the droplet entering the trap is greater than the trap length, then a sequence of two droplets is obtained at the trap exit, whereas the first of these droplets has a volume of the trap, and the second one has a volume equal to the difference between the volume of the entering droplet and the trap volume (FIG. 4b), where x is the direction of flow and y is time.

In a similar embodiment of the invention a bidirectional trap is obtained. The bidirectional variant of the metering trap is shown in FIG. 5, in a top view (main drawing), and in sections along the AB line (bottom drawing) and along the CD line (drawing on the right) lines. Compared with the trap shown in FIG. 1, the version presented in FIG. 5 comprises additional second barrier 4a in the microfluidic channel 1, identical with the first barrier and located at a distance of 0.4 mm to a few millimetres therefrom (as measured along the direction of flow). The side channels of identical depth of 100 μm, running symmetrically with respect to the microfluidic channel 1, are from 0.4 mm to several millimetres long and start at the first barrier 4a and terminate at the second barrier 4a. Each side channel is connected with the microfluidic channel 1 through the inlet 7 of the side channel 5 and the outlet 8 of the side channel 5, and connected with the obstruction 4a, whereas the lumen of the inlet 7 of the side channel 5 and the outlet 8 of the side channel 5 is reduced as compared with the lumen of the side channel at a place located between its inlet 7 and outlet 8, preferably by minimum 50%, and more preferably from 66% to 75%. “Reduction of the lumen” shall mean the reduction of the surface area of the channel's cross-section. In particular, it can be achieved by narrowing or shallowing of the side channel 5 in the area of inlet 7 and outlet 8 of the side channel. Reduction of the lumen of the bypass 5 at its inlet 7 and outlet 8 to the main channel 1 is necessary for correct trap operation. As a result, there is a barrier preventing the droplet locked in the trap from entering the bypasses. This is a prerequisite for an efficient separation of the flow of the continuous phase through the side channels from the flow of the droplet phase through the main channel.

Also in this case, all modifications of the trap design, as described with reference to FIG. 1, in the section “Possible trap modifications”, are permissible. The distance between the first and the second barrier 4a can be adjusted as needed, and the first and the second barrier need not be equally deep.

The operation of the bidirectional trap is the same as that of the unidirectional one described earlier. The difference between the unidirectional and the bidirectional traps appears when the direction of flow is reversed. Due to the fact that the bidirectional trap is symmetric, its operation is the same irrespective of the direction of flow. Hence, the trap has the same effect on droplets flowing through it as the unidirectional trap described earlier, no matter what direction the droplets are coming from. For the unidirectional trap, the droplets flowing upstream are neither stopped nor metered in the trap—they flow freely through the trap. The droplets generated earlier in the unidirectional trap are washed out from the trap once the flow is reversed. For the bidirectional trap, the locked droplet is not washed out from the trap after the flow is reversed. Likewise, as the unidirectional trap, the bidirectional trap allows for pushing out droplets with consecutive droplets arriving through the channel, both using droplets larger and smaller than the trap volume.

### Example 2

### Merging Trap

FIG. 6 shows schematically an unidirectional (a) and a bidirectional (b) merging trap, in a top view (main drawing) and in two sections along the AB and CD lines (drawings on the right). The structure of the merging trap differs only by the obstruction used in this trap: instead of the barrier 4a, a side intrusion 4b is used here. The side intrusion has been produced by fabricating an additional channel in the barrier 4a, parallel to the main channel passing through the centre of the barrier. The channel increases the lumen for the flow of a droplet through the obstruction. The result of the modification is that the deformation of droplet in the area of the side intrusion is not large enough to lead to cutting of the droplet, as presented in earlier examples where the barrier 4a was used instead of the side intrusion 4b.

The effect a bidirectional merging trap has on a droplet is shown in FIG. 7 and FIG. 8, where x is the direction of flow and y is time.

When a droplet 4 shorter than the trap approaches the trap, it stops at the side intrusion 4b behind the side channels 5. The continuous phase flows around the droplet 4 through the side channels, whereby the force exerted by the flow on the rear of the droplet 4 is too low to push it through the side intrusion (FIG. 7b).

When a droplet 4 longer than the trap approaches an empty trap, then when the front of the droplet 4 arrives at the side intrusion 4b behind the side channels 5, the rear of the droplet 4 is still in the main channel 1, outside the trap. Therefore, the force exerted by the flow on the rear of the droplet is sufficient to push the front of the droplet 4 through the side intrusion 4b. Unlike the metering trap described above, the side intrusion 4b causes smaller droplet deformation than the barrier 4a. Consequently, when a droplet enters the trap, it is not broken at the side intrusion 4b, and the entire droplet 4 goes out of the trap (FIG. 7a).

When a subsequent droplet arrives at the trap already containing a locked droplet, and the merging of both droplets results in a droplet larger than the trap volume, then such a droplet leaves the trap (FIG. 8). In particular, when a series of droplets smaller than the trap volume moves toward the merging trap, subsequent droplets will merge in the trap until their total volume exceeds that of the trap. Thus, at the trap exit, a series of identical droplets of a volume larger than that of the trap is obtained.

As for the metering trap, the difference between the unidirectional and the bidirectional versions can be seen if the flow is reversed. The unidirectional trap stops only droplets flowing in one direction, so that a droplet trapped by the trap is washed out when the direction of flow is reversed. In the case of a bidirectional metering trap, a droplet, once trapped, is locked in the trap, even if the direction of flow varies.

In this case also, all modifications of the trap design, as described with reference to FIG. 1, in the section “Possible trap modifications”, are permissible. The distance between the first and the second side intrusion 4b can be adjusted as needed, and the first and the second side intrusions need not be equally wide.

### Example 3

### Hybrid Metering-Merging Trap

Another modification of the traps described above can be a trap differing from preceding traps in that it has different obstructions at both termini. The device shown in FIG. 9 in a top view (main drawing), and in sections along the AB line (bottom drawing), and the CD and EF lines (drawings on the right), comprises a side intrusion at the entrance, and a barrier at the exit of the trap. Due to this structure, the device works as a metering trap for forward flowing droplets, and as a merging trap for droplets flowing in the opposite direction.

When a forward flowing droplet of a volume larger than the trap size approaches the trap, then the end of the droplet is locked in the trap. Subsequently, when the flow is reversed, the droplet still remains in the trap, but when a droplet flowing in the opposite direction approaches the trap, it will flow into the trap, merge with the locked droplet and a large droplet so formed is released from the trap.

In this case as well, all modifications of the trap design, as described with reference to FIG. 1, in the section “Possible trap modifications”, are permissible. The distance between the first and the second obstruction can be adjusted as needed, and the dimensions of the obstructions need not be identical.

### Example 4

### Modification of Traps from Preceding Examples Consisting in Adding Additional Elements Separating the Side Channels from the Main Channel

The traps described in examples 1, 2 and 3 can be modified by adding baffles 6 separating the main channel from the side channels 5, where the baffles do not run along the entire length of the trap, but are shorter, thus leaving connections between the main channel 1 and the side channels 5 at the entrance and the exit of the trap. This allows the continuous phase to flow into the side channels 5 at the exit of the trap only, and to flow out at the exit of the trap only.

Such a trap is shown schematically in FIG. 10 in a top view (main drawing), and in sections along the AB line (bottom drawing), the CD line (drawing on the left), the EF line (drawing on the right), and the GH line (upper drawing).

The addition of the baffles does not change essentially the operation of a metering trap so modified, if it is initially filled with a droplet of a length equal to that of the trap, or if an empty trap is approached by a series of droplets longer than the trap length. As described in Example 1, the size of the droplets leaving the trap is equal to the size of droplets entering the trap. The trap locks a constant volume of the droplet phase.

However, the operation of such a trap is completely different to that of the traps described earlier, if a series of droplets shorter than the trap approaches the trap. The first droplet stops at the trap, as is the case for the traps from Examples 1 and 2. The second droplet entering the trap, though, causes the continuous phase to flow through the main channel 1. The continuous phase, blocked by the droplet entering the trap and the baffles, must press against the droplet locked earlier in the trap, leading to the pushing of the droplet through the barrier or side intrusion. The droplet that has arrived, replaces the preceding droplet and is locked until the next droplet arrives.

This is illustrated in FIG. 11: a)—a droplet 4 is locked in the trap, the external phase can freely flow around it through the side channels 5; b)—subsequent droplet 13 approaches the trap; c) the droplet entering the trap 13 blocks the inlet 7 to the side channel 5, forcing the continuous phase to flow through the main channel and push out the droplet 4 locked earlier in the trap; d)—droplet being pushed out passes the trap barrier 4a; e)—droplet that entered the trap 13 moves along the channel; and f)—finally stops at the trap barrier 4a.

This allows for immobilisation of droplets flowing in series for a certain period of time. A droplet is released from the trap as a result of a subsequent droplet approaching the trap. Locking a droplet for a certain period of time at a specific place is advantageous, particularly when single droplets are to be measurement. Especially advantageous is the mechanism wherein a droplet is directly released from the trap, thus preventing droplets from sticking together.

The baffles can also be used to stabilise the droplet volume in a trap of large design and/or with different trap shapes. A circular trap can be used as an example, where the very trap has a circular shape with a diameter several times greater than the width of the main channel. In this case, when the baffles 6 separating the droplet 17 from the side channels 5 are not used, the shape of such droplet 17 would be unstable and the droplet liquid would be pushed into the side channels 5. The use of baffles 6 allows for correct operation of such a device, which is illustrated in FIG. 12: a)—droplet 4 approaches the trap filled with droplet phase 17; b)—droplet 4 flowing into the trap contacts the locked droplet 17, which results in merging of both droplets; c)—in line with absorption of the incoming droplet 4 by the droplet in the trap 17, the same volume of droplet liquid 21 is released at the other terminus of the trap; d)—after absorption of the entire incoming droplet 4 at one terminus of the trap, a droplet of identical volume 21 is released at the other terminus of the trap (compare a) and b), droplets 4 and 21). The emerging droplet 21 moves further, carried by the flow of the continuous liquid, whereas the same droplet volume still remains in the trap (compare a) and b)).

### Example 5

### Generation of Droplets of Predetermined Size by Reversing Flows

The metering trap can be used to generate droplets of predetermined size in the system. As shown in Example 1, a long droplet 4 flowing through the trap is divided so that a droplet 19 of the size determined by the trap volume is cut from its end. The droplet 19 is locked in the trap. Such droplet 19 can be washed out from a unidirectional metering trap after flow reversing. This property of the device allows for displacement of the droplet generated in the trap 19 to a different location within the system and for performing subsequent operations on it. A scheme of a device working in line with the algorithm described above and the consecutive phases of its operation are shown in FIG. 13, where the arrows show the direction of flow.

### Example 6

### Dilutor

Single metering trap can be used as a device diluting a portion of an active ingredient and generating a series of droplets with varying concentration. In this case the trap is filled with the active ingredient that forms therein a droplet 21 of a volume predetermined by the geometry of the trap. When a series of solvent droplets 4 of a volume smaller than the trap volume is guided to a so filled trap, then, as a result, the trap releases a sequence of droplets 25 of a size identical with that of droplets 4 entering the trap, but with a decreasing concentration of the active ingredient.

This embodiment takes advantage of the fundamental property of metering units, where a droplet entering the trap merges with a locked one. The added volume from the new droplet moves forward and arrives at the entrance of the trap causing generation at the trap exit of a droplet of the same volume as the droplet entering the trap (FIG. 14). The process of droplet absorption by the trap and the simultaneous release of a new droplet is too fast to allow for the solvent from the droplet entering at the front of the trap to be mixed in the entire trap. The droplet entering the trap has, therefore, no effect on the concentration of the droplet released at the terminus of the trap. Thus, the concentration of the released droplet is the same as that before the solvent droplet arrives at the trap. After adding the solvent droplet to the trap, the solvent volume from the added droplet mixes with the solution of the active ingredient in the trap, resulting in decreasing concentration of that ingredient in the trap. Subsequent droplet entering the trap results in releasing a droplet of concentration lower than the preceding droplet.

The concentration of the i-th droplet released from the trap can thus be expressed with the formula:

Cᵢ=Cᵢ₋₁(Vₜ−V_{d})/Vₜ=Cₒ((Vₜ−V_{d})/Vₜ)ⁱ

where Cᵢ is the concentration of the i-th droplet, Vₜ—the trap volume, V_{d}—the volume of a droplet entering the trap. More generally, when the volumes of droplets entering the trap do not vary, the above equation can be written as:

Cᵢ=Cₒαⁱ

where α=(1−V_{d}/Vₜ).

The mechanism of generation of serial dilutions will be operative if i) Vd<<Vₜ, ii) the time period between entering the trap by consecutive droplets will be appropriately long, so that the solvent has enough time to uniformly mix together in the trap.

The plot in FIG. 15 shows results of the experiment, in which an ink droplet was diluted with droplets of water. The plot shows ink concentration (x axis) as a function of droplet number (y axis).

### Example 7

### DOMINO

The metering and merging traps demonstrated in preceding examples can be used in complex systems performing precise operations on droplets without using active (i.e., requiring power supply) components with complex structures, but only by changing the direction of the liquid flow in channels. The device presented here 200 allows for generation of a static series of droplets with decreasing reagent concentration.

A scheme of an embodied system is presented in FIG. 16. The system 200 comprises a long channel 29 (here in meander-shaped pattern in order to minimise the size of the device). The main channel branches at both termini. Each branching comprises two branches, one of which leads to the inlet 18, and the other one to the outlet 20 of the continuous liquid. The solution is used to reverse the flow in the main channel by opening the inlet 18 at one terminus of the channel and the outlet 20 at the other terminus of the channel.

The channel passes through a series of five unidirectional metering traps 28 of identical volumes and oriented in the same direction. Four merging traps 27 of identical volumes are placed between the metering traps. The ratio of the volume of the merging trap to that of the metering trap is about 5/4.

Besides, a metering trap 22 of a volume two times larger than the volume of the remaining metering traps 28 is positioned at the beginning of the channel 29 and oriented in the opposite direction as compared with other traps 28. The inlets of two additional channels, the first of which is terminated with the inlet of the sample 26, and the second with the inlet of the solvent 24, are positioned between the large trap 22 and a series of alternately placed metering 28 and merging 27 traps.

The system operation confines to switching on and off the flows between the corresponding inlets and outlets of the system. In each phase of operation, only one inlet and only one outlet are active. FIG. 17 a)-e) shows schematically the directions of flow in consecutive phases of system operation. Phases a) and b) comprise the preparation of droplets of the solvent, and phases c) and d) the preparation of droplets of the sample. Phase d) comprises the transport of solvent droplets to the merging traps. Phase e) is the proper DOMINO action, in which the droplets of the sample are diluted in the droplets of the solvent.

FIG. 18: shows images illustrating the operation of the DOMINO system in phases a) d) shown in FIG. 17.

a)—Solvent injection—activation of the flow of solvent 66 and simultaneous opening of the outlet 67 shown in the bottom of the drawing (according to the orientation of the drawing) results in entering a long stream of solvent 66 in the main channel 29.
b)—Starting the flow of the continuous phase 68 through the system results in the detachment of the solvent volume 66 located in the channel 29; a large drop of solvent 66 produced in this way is transported by the flow along the system. The passing of the long droplet of solvent 66 by each metering trap 28 results in detachment of small droplets 69 (locked in the traps) from the end of the large drop 66;
c)—Injection of a portion of reagent 70 to the system through the sample inlet 26.
d)—Starting the flow of the continuous phase 68 through the system in the direction opposite to the direction of flow in the phase b) (from the bottom upwards). It results in formation of a droplet 71 of the sample 70 with a size predetermined by the geometry of the metering trap—in this case the resulting droplet 71 of the sample 70 is two times longer than the solvent droplet 69. Simultaneously, the solvent droplets 69 are washed out by the reversed flow from unidirectional metering traps and are locked in merging traps 27.

At this stage the system is ready for the last phase, which follows the switching on of the flow from the top downwards and comprises serial dilution of the sample with the solvent.

FIG. 19 shows the mechanism of generation of serial dilutions.

a)—Droplet of the sample 71 is washed out from the unidirectional trap 22. Droplets of the solvent 69 are too short to get out of the symmetric merging traps 27 in spite of continuing flow of the continuous phase 68.
b)—Droplet of the sample 71 arrives at the first metering trap 28.
c)—Droplet of the sample 71 passes through the metering trap 28 that divides it into two droplets of identical length, 71a and 71b, one of which 71a moves further with the flow, while the other 71b remains locked in the first metering trap. Hence, the first metering trap locks the droplet of concentration Co.
d)—Droplet released from the metering trap 71a enters the merging trap where it merges with a droplet of the solvent 69. The resulting droplet 72 is too large to be locked in the merging trap 27 and passes through it.
e)—Droplet 72 resulting from the merging of the droplet of the sample 69 with that of the solvent 71a moves through the channel, whereby materials from both droplets mix thoroughly with each other. Since the droplets are of approximately the same length, the resulting reagent concentration is ½ Cₒ.
f)—Long droplet 72 arrives at the subsequent trap. The situation is analogous as in case b), only here the concentration in the long droplet 72 is reduced by a factor of ½. The passing of the droplet through subsequent segments results in serial dilution of the sample and in the locking of gradually diluted droplets in subsequent traps.
g)—Droplets resulting from serial dilution locked in the metering traps. Counting from top, five locked droplets comprise the following concentrations: Cₒ, ½Cₒ, ¼Cₒ, (⅛)Cₒ, ( 1/16)Cₒ.

In the example described above, in consecutive segments of the system the concentration is reduced by a factor equal to the ratio of the volume of the droplet of the sample to the sum of volumes of both droplets (the sample and the solvent). Since the concentration is determined geometrically by the size of mixed droplets, such system allows for precise dilution of the sample.

In general case, the concentration change in a single segment of the system can be written with the formula:

Cᵢ+1=Cᵢ(Vₖ−Vₚ)/(Vₖ)=Cᵢ(1−Vₚ/Vₖ)

where Cᵢ means the concentration in the i-th trap, counting from top (whereas the numbering of traps starts with i=o), Vₖ is the volume of the large trap, where the initial droplet of the sample is generated, and Vₚ is the volume of shorter traps.

Generally, the concentration in the i-th trap can be written as follows:

Cᵢ=Cₒαⁱ

where Cₒ is the concentration in the initial droplet, and the coefficient α=(1−Vₚ/Vₖ) is from interval (0,1).

Each step of operation of the device described in this example consists in switching on of the appropriate flows. Time period required for each step cannot be too short. No limitation, however, is imposed on the time period. The reason is that any arbitrarily large volume of the sample and the solvent to be introduced to the system can be required for the correct system operation, not less, however, than the volume that is needed to fill all the traps.

Based on the device disclosed here one can construct further more advanced devices, where droplets with varying reagent concentration are washed out from traps, transported to other system components or are subject to further operations.

### Example 8

### Trapostat

Another example of the use of traps is a system taking advantage of an array of traps for trapping of a static cluster of droplets and controlling reagent concentrations individually in each droplet. In this case, each droplet in a trap acts as a single incubator, well isolated from its surrounding and allowing for precise varying concentrations of active ingredients. Such devices can be used in studies on bacterial populations or cell cultures.

Such a system 400, as schematically illustrated in FIG. 20, comprises an inlet 2 to a multiply branched channel, forming the structure of a tree with many terminals. Each terminal branching enters a metering trap 28, and so the entrance to the system is connected with each trap. Similar branching system can be used to connect each trap with the exit of the device 3. An externally controlled valve 74 or other component allowing for active control of the hydrodynamic resistance of the system is placed behind each metering trap 28.

The valves 74 are used for addressing of the active trap. If all valves 74 behind the traps 28 are closed, and only the valve 74 behind a selected trap 28 is open, then if a flow is forced between the entrance 2 and the exit 3 of the system, it will take place only through the selected trap 28.

This mechanism is used to transport droplets to a selected droplet. Droplets of appropriate size and appropriate analyte concentration, generated in an external, automated device are transported to the entrance of the trapostat 400, and further carried by the flow to a selected trap. In the trap, the arriving droplet merges with the locked droplet, while simultaneously pushing out a portion of the old droplet. In that way, the concentration inside the locked droplet is varied, similarly as described in example 6.

The solution disclosed here allows for operations on an entire array of immobilised droplets by a microfluidic device that comprises only one inlet and outlet and an external on-demand droplet generator. The number of external valves needed for operating of large arrays does not need to be equal to the number of traps, and can be significantly reduced using solutions reported earlier [T. Thorsen et al., Science, 298, 2002, 580].

### Example 9

### Trap with a Baffle and One Bypass

FIG. 21 shows micrographs of a system used for studying phenomena at the interface between two droplets, 78 and 80. The device comprises two traps. One of them is used to lock the droplet that enters the trap from an additional channel (round, transparent droplet, 80). The second trap functions identically as the trap from example 4 (FIG. 11), but comprises only one side channel (bypass) 5. The trap locks droplets entering it 78. A droplet 78 locked in the trap is released from the trap once another droplet enters the trap. As a result, transparent droplet 80 locked in the static trap contacts from time to time with subsequent coloured droplets 78 from an earlier prepared sequence.

Such systems can be used in studies on lipid bilayers emerging at the interface between surfaces of two droplets.

### Example to

### Derailer Module

### The Loop Problem

In a network of branched channels droplets may have multiple choices of how to get from point A to point B.

Even in the simplest case in a network with two branches and with a common inlet and outlet (referred to as a loop) movement of the droplets is driven by two phenomena. The first is the resistance of the (branch of the) channel, which can be expressed in the terms of the pressure drop given by the Hagen-Poiseuille equation:

$$Δ P = \frac{8 μ L Q}{π {r}^{4}}$$

where:
ΔP is the pressure drop
L is the length of channel
μ is the dynamic viscosity of the fluid
Q is the volumetric flow rate
r is the radius of the channel

Clearly, if the possible outlet channels (branches) have the same (or similar) cross section at the junction, droplets choose the branch with the lower resistance. Droplets inside a channel increases resistance. Consequently, in a loop with two identical branches, droplets (of the same size/volume) flow into left and right branches in turn.

The second attribute that influences which branch a droplet chooses is the geometry (shape) of the branches at the junction. Droplets try to minimize their surface area, which results in a pressure difference between the inside and outside of the droplet, called the Laplace pressure:

$$Δ P ≡ {P}_{in} - {P}_{out} = γ ( \frac{1}{{R}_{1}} + \frac{1}{{R}_{2}} )$$

where:
ΔP is the pressure difference (Laplace pressure)
γ is the interfacial tension between the two phases
R₁ and R₂ are the mean curvature of the droplet (the front and at the rear)

When a droplet is forced to flow through a contraction its shape undergoes deformation, which results in an increased pressure drop along the droplet. Therefore, in a single loop with both branches having the same (or similar) resistance, droplets choose the branch that has a larger (and more symmetrical—e.g. square) cross section. In a loop having one branch with high resistance, but large and symmetric cross section at the junction, and the other branch having low resistance, but a narrow inlet at the junction to this branch, the competition between these two laws determines the direction of flow for the droplet.

Thus, it should be possible to fabricate a loop where droplets choose to flow via the branch with higher resistance. Moreover, using a simple design it should also be possible to pre-determine different paths for droplets depending upon the direction of flow.

### Design and Operation of a Derailer Module

FIG. 22 shows a schematic illustration of a classic microfluidic loop of constant height (a)), compared to a derailer (b)).

In the derailer shown, droplets move via one branch 10 (e.g. to the right and down) for a given direction of low, while reversing the direction of flow transports droplets via the other branch 10 (e.g. to the left and up). The operation of such a “one-way router” relies on the different shape (cross section) of the two branches at the junctions 12.

The cross section of the inlet 2 and outlet 3 channels are constant/uniform (for example, w=h=400 μm). From the inlet junction 14, the height of one of the branches is preserved along its length half way to the next junction (exit junction), then it gradually decreases from h to h/4 at the point where it joins the exit junction (and outlet channel), which has the height h. The loop is anti-symmetric, meaning that in the opposite direction the other branch 10, at the outlet junction 16, has the same geometry. As a result, at either junction 12, the inflowing droplet has to choose between a branch 10 of cross section w×h and a branch 10 of cross section w×(h/4). Although resistance in the loop from the inlet 2 to the outlet 3 is the same via both branches 10, in the derailed loop, droplets, in order to minimize their Laplace pressure, always chose the branch with the largest cross section at the junction 12. Moreover, even when the resistance in the “driving branch” increases due to the increasing number of inflowing droplets, it is still more convenient for the droplets to choose that branch than to undergo large deformation of their shape.

Unlike in a classic loop with uniform height, where droplets 4 flow into one and the other branch 10 in turns, as shown in FIG. 23, top row, in the de-railed loop droplets 4 always flow in one branch 10 for a given direction of flow and then when the direction of flow is reversed always flow trough the other branch to, as shown in FIG. 23, bottom row.

It is important to note that instead of decreasing the height of the channel (branch), the width of the channel (branch) can be decreased instead with the same result. This enables fabrication of derailing loops using methods involving only single layer planar designs, such as standard soft lithography.

Various loops and networks can be fabricated, as shown in FIG. 24, using non-uniform geometry to drive the droplets on in a pre-determined path, and then, by simply changing the direction of the flow, to redirect (“derail”) them to another track (analogously to the railways). The inventors believe these derailing loops are important.

### Possible Applications

The above derailing loops can be used in a number of microfluidic droplet driving and sorting applications, since this passive method is simple, inexpensive and is easy to fabricate using both planar or 2.5D fabrication methods.

For example, using the metering and merging traps referred to above [Korczyk et al., Lab Chip, submitted] droplets can be driven via one channel into a metering trap, cut to a precise volume and then released via another channel using the derailer unit. Moreover, placing a merging trap module in the second (release) channel and having two inlets with different samples, a fusion of two precisely metered droplets can be achieved regardless of the initial volume of the two injected samples. A schematic illustration of a single unit of such a system is shown in FIG. 25.

The following steps are required for operation of the system referred to directly above:
a)—continuous phase inlet 34 and outlet 32 are closed, continuous phase is injected from continuous phase inlet 30 to outlet 36, a long droplet of sample “sample 1” is injected from inlet 38 and the droplets transports via the upper branch into the metering trap 42, where it is metered to volume V. The excess of “sample 1” flows out through outlet 36;
b)—continuous phase inlet 30 and outlet 36 are closed, the flow is reversed by injecting continuous phase from continuous phase inlet 34 to outlet 32. This drives the metered “sample 1” from the metering trap 42 via the lower branch to the merging trap 44 (of volume 1.5V) where it becomes locked;
c)—continuous phase inlet 34 and outlet 32 are closed again, the flow is reversed again by injecting continuous phase from continuous phase inlet 30 to outlet 36 again. “Sample 2” is injected from inlet 40 and just like in step 1 is metered to volume V in the metering trap 42; and
d)—continuous phase inlet 30 and outlet 36 are closed again, the flow is reversed again by injecting continuous phase from continuous phase inlet 34 to outlet 32. “Sample 2” of volume V is transported into the merging trap 44 where it fuses with “sample 1” of volume V and leaves the trap.

Using the derailer, metering and merging traps in combination, a system for the simultaneous generation of a series of droplets with constant volume and constant concentration in two separate branches can be fabricated. By reversing the flow, droplets from the two branches can be merged. Such function can find application e.g. in medical point of care devices (POC), where, for example, droplets with a constant concentration of bacteria can be merged with a gradient of antibiotics to estimate the minimum inhibitory concentration (MIC). The design for such a system is shown in FIG. 26.

The following steps are required for operation of the system referred to directly above:
a)—a long droplet with a concentration of antibiotics is injected from inlet 40 to continuous phase outlet 32 (all other inlets/outlets are closed), through a long metering trap 48 (left from 40), which cuts a droplet of volume 2V with a concentration of antibiotics C_{Ao};
b)—continuous phase inlet 34 and outlet 32 are closed, a long droplet of a solution with bacteria of concentration CB is injected from inlet 38 and a long droplet of solvent is injected from inlet 40 simultaneously. After that, continuous phase is injected from inlet 30 to outlet 36 and transports the long droplets of bacterial solution and solvent in the upper and lower channels, respectively, through the series of metering traps (of volume V) 42, that cut the long droplets into portions. At the same time, the already metered droplet (in step 1) containing the antibiotics (with C_{Ao}) is released from the 2V-metering trap (40) and dilutes the metered solvents in the lower channels 42, creating droplets with a gradient of concentration C_{Ao}/2, C_{Ao}/4, C_{Ao}/8, etc. (functionality similar as for the DOMINO device); and
c)—continuous phase inlet 30, outlet 36 and outlet 32 are closed, the direction of flow is reversed, and continuous phase is then injected from inlet 34 to outlet 46. Having the loops derailed, the metered droplets from metering traps 42, instead of flowing back via the same path, derail into the middle channel and flow into the merging traps 44, where droplets containing the bacteria merged with the droplets containing the antibiotics of various concentration.

Having the volume of the merging traps 44 <2V (but >V) droplets after fusion proceed to outlet 46 for further analysis, or having the volume of the merging traps 44 >2V, causes the droplets to lock in position.

### Example 11

### Digital Dilution Droplet PCR

This microfluidic system allows for generation of a static series of droplets with decreasing amount of amplicons (copies of target DNA to be amplified) that are subsequently amplified in PCR reaction.

The chip, FIG. 27, is made of PDMS bonded to silicon wafer and comprise 21 hydrodynamic traps: section 50 with 4 metering traps 42 with decreasing volume with the ratio of 2. Sizes of subsequent metering traps are: 4.8 μl; 2.4 μl; 1.2 μl; 0.6 μl; section 52 with 16 metering traps of identical volumes equal to 0.3 μl that are used for serial dilution of the sample; and auxiliary trap 53 needed for metering the portion of sample to be diluted.

The continuos phase is perfluorinated oil FC-40 with 1% 1H,1H,2H,2H-perfluorooctanol as a surfactant.

The reaction master mixture consisted of 4 μl of 5× concentrated Light Cycler TaqMan Master, 2 μl of mix of primers, 2 μl of solution with FAM-labeled hydrolysis probes, 7 μl of PCR-grade water and 5 μl, of wild-type plasmid DNA as a quantification standard. The buffer solution has the same composition, excluding wild-type plasmid DNA which is replaced with 5 μL of PCR-grade water.

The operation of the system is confined to switching on and off flows between the corresponding inlets and outlets of the system. In each phase of operation, only one inlet and only one outlet are active. The system is filled with continuous phase prior to operation.

The mechanism of generation of serial dilutions for digital PCR is as follows:
a)—Solvent (PCR mixture that does not contain amplicons) injection through the inlet 54—activation of the flow of solvent and simultaneous opening of the outlet 55 results in a long stream of solvent entering the channel 56 and section 52.
b)—Starting the flow of continuous phase through the inlet 57 in to the system, results in the detachment of the solvent volume located in the channel 56; the large drop of solvent produced in this way is transported by the flow along the system. The passing of the long droplet of solvent by each metering trap 42 in the section 52 results in detachment of small droplets (locked in the traps) from the end of the large drop.
c)—Injection of a portion of sample (PCR mixture that does contain amplicons) in to the system through the inlet 58—activation of the flow of solvent and simultaneous opening of the outlet 59 results in a long stream of solvent entering the channel 60.
d)—Flow of the continuous phase through the inlet 57 in to the system results in the detachment of small droplets of sample from auxiliary trap 53 and the metering traps 44 in section 51. The volume of droplets with sample in the metering traps in section 51 rises gradually by a factor of 2.

At this stage the system is ready for the second phase, which follows the switching on of the flow through the inlet 61 and comprises serial dilution of the sample form auxiliary trap 53 with the droplets of solvent locked in section 52.

The mechanism of generation of serial dilutions in section 52 is as follows:
a)—Droplet of the sample is washed out from the auxiliary trap 53.
b)—Droplet of the sample arrives at the first metering trap 64 in the section 52.
c)—Droplet of sample (˜0.6 μl) fuses with the droplet of solvent (˜0.3 μl) locked in the trap. The newly formed droplet passes through the metering trap that divides it into two droplets with ratio 2:1, one of which moves further with the flow, while the other remains locked in the first metering trap 62. Almost the whole volume of solvent is pushed out from trap together with excessive volume of sample. Hence, the first metering trap 62 locks the droplet of concentration of amplicons Cₒ—equal to the concentration of sample in auxiliary trap 53 and in the section 50.
d)—Droplet resulting from the merging of half of the droplet of the sample with that of the solvent moves through the channel 63, whereby materials from both droplets mix thoroughly with each other.
e)—Since the droplet of the buffer is of approximately the same volume as half of the droplet with sample, the resulting amplicon concentration is ½ Cₒ.
f)—Long droplet arrives at the subsequent trap 64. The situation is analogous to the situation in step c), only here the concentration in the long droplet is reduced by a factor of ½. The passing of the droplet through subsequent metering traps results in serial dilution of the sample and in the locking of gradually diluted droplets in subsequent traps.
g)—Droplets resulting from serial dilution locked in the metering traps. Counting from trap 62, sixteen locked droplets in section 52 comprise the following concentrations: Cₒ, ½Cₒ, ¼Cₒ, (⅛)Cₒ, ( 1/16)Cₒ . . . ( 1/32768)Cₒ.

In general the amount of DNA decreases gradually in subsequent traps of the system: in the section 50 it is realized by reduction of volume of subsequent traps, whereas in section 52 concentration is changed by the factor of ½.

The next step of the reaction is amplification. The chip is not disconnected from its tubings, but is placed directly on a flat heating block in a TC-5000 Techne termocycler. Additional pressure of 600 mbar is applied to avoid formation of bubbles during heating of the chip. The PCR reaction protocol is as follows:
DNA initial denaturation step of 5 min at 95° C.; and
35 cycles of amplification:
   DNA denaturation step of 10 s at 95° C.;
   a primer annealing step of 30 s at 60° C.; and
   a DNA extension step of 1 s at 72° C.

After the final cycle the PCR chip is stored in the cycler at 4° C. before imaging. Fluorescence images were acquired with DS-1QM/H digital camera mounted to a Nikon SMZ 1500 steromicroscope with 0.5× Apo Plan objective. Positive signals are observed only in droplets having at least one amplicon before the PCR reaction.

1. A microfluidic device (100) comprising a microfluidic channel (1) comprising an inlet (2) and an outlet (3), and configured to allow liquid to flow therebetween along a direction of flow, the microfluidic channel (1) comprising at least one obstruction (4a, 4b) extending thereacross such that the transverse dimension of the microfluidic channel (1), as measured in a direction perpendicular to the direction of flow, is less than the transverse dimension of the microfluidic channel (1) at a point spaced apart from the obstruction (4a, 4b), the device (100) further comprising at least one side channel (5) comprising an inlet (7) and an outlet (8), and configured to allow liquid to flow therebetween, the side channel (5) being connected to the microfluidic channel by its inlet (7) and outlet (8), such that its outlet (8) coincides with the obstruction (4a, 4b), and wherein the lumen of the inlet (7) and the outlet (8) of the side channel (5) is less than the lumen of the side channel (5) at a position between its inlet (7) and outlet (8).

2. A microfluidic device (100) according to claim 1, wherein the transverse dimension of the microfluidic channel (1), as measured in a first direction perpendicular to the direction of flow, is h₁, and the obstruction (4a) comprises a barrier (4a) extending across the channel (1), wherein the transverse dimension, h₂, of the microfluidic channel (1), as measured in the first direction perpendicular to the direction of flow, is h₂<h₁.

3. A device according to claim 2, wherein 0.1 h₁≦h₂<0.5 h₁, more preferably 0.15 h₁≦h₂<0.4 h₁, most preferably 0.25 h₁≦h₂<0.33 h₁.

4. A device according to claim 2, wherein the shape of the barrier (4a), as seen when looking in the first direction perpendicular to the direction of flow, is semicircular or rectilinear.

5. A device according to claim 2, wherein the width of the barrier (4a), as measured in the direction of flow, is from 0.25 h₁ to 2 h₁, more preferably from 0.3 h₁ to 1.5 h₁, most preferably from 0.3 h₁ to 0.6 h₁.

6. A device according to claim 2, wherein the microfluidic channel (i) comprises a second obstruction which comprises a second barrier (4a) extending across the channel (1), wherein the transverse dimension, h₂₂, of the microfluidic channel (1), as measured in the first direction perpendicular to the direction of flow, is h₂₂<h₁.

7. A device according to claim 6, wherein the second obstruction is disposed along the microfluidic channel (1) and spaced apart from the first obstruction.

8. A device according to either claim 6, wherein 0.1 h₁≦h₂₂<0.5 h₁, more preferably 0.15 h₁≦h₂₂<0.4 h₁, most preferably 0.25 h₁≦h₂₂<0.33 h₁.

9. A device according to claim 6, wherein the shape of the second barrier (4a), as seen when looking in the first direction perpendicular to the direction of flow, is semicircular or rectilinear.

10. A device according to claim 6, wherein the width of the second barrier (4a), as measured in the direction of flow, is from 0.25 h₁ to 2 h₁, more preferably from 0.3 h₁ to 1.5 h₁, most preferably from 0.3 h₁ to 0.6 h₁.

11. A microfluidic system, comprising one or more microfluidic devices according to claim 1.

12. A microfluidic system according to claim 11, wherein the one or more microfluidic devices are configured to allow fluid to flow either unidirectionally or bidirectionally.

13. A microfluidic system according to claim 11, wherein the system comprises means for mixing droplets, preferably in the form of a channel section with a larger lumen, a channel section with a varying channel lumen, or in the form of a meandering section of the microfluidic channel.

14. A polymerase chain reaction (PCR) apparatus comprising a microfluidic device according to claim 1.

15-43. (canceled)

44. A microfluidic device (100) comprising a microfluidic channel (1) comprising an inlet (2) and an outlet (3), and configured to allow liquid comprising continuous fluid that wets the walls of the channels (1,5) and a droplet of a liquid that does not wet the walls of the channels (1, 5) to flow therebetween along a direction of flow, the microfluidic channel (1) comprising at least one obstruction (4a, 4b) extending thereacross such that the transverse dimension of the microfluidic channel (1), as measured in a direction perpendicular to the direction of flow, is less than the transverse dimension of the microfluidic channel (1) at a point spaced apart from the obstruction (4a, 4b), the device (100) further comprising at least one side channel (5) comprising an inlet (7) and an outlet (8), and configured to allow liquid to flow therebetween, the side channel (5) being connected to the microfluidic channel by its inlet (7) and outlet (8), such that its outlet (8) coincides with the obstruction (4a, 4b), and wherein the lumen of the side channel (5) at a position of the inlet (7) and the outlet (8) of the side channel (5) is less than the lumen of the microfluidic channel (1) between inlet (7) and outlet (8) such that the channel geometry and Laplace pressure related the surface tension on and curvature of the surface of a droplet cause separation of the flow of the continuous phase through the side channel (5) from the flow of the droplet through the microfluidic channel (1).

45. A microfluidic device (100) comprising a microfluidic channel (1) comprising an inlet (2) and an outlet (3), and configured to allow liquid comprising continuous fluid that wets the walls of the channels (1,5) and a droplet of a liquid that does not wet the walls of the channels (1, 5) to flow therebetween along a direction of flow, the microfluidic channel (1) comprising at least one obstruction (4a, 4b) extending thereacross,
wherein the transverse dimension of the microfluidic channel (1), as measured in a first direction perpendicular to the direction of flow, is h1, and the obstruction (4a) comprises a barrier (4a) extending across the channel (1), wherein the transverse dimension, h2, of the microfluidic channel (1), as measured in the first direction perpendicular to the direction of flow, is h2<h1,
the device (100) further comprising at least one side channel (5) comprising an inlet (7) and an outlet (8), and configured to allow to flow therebetween, the side channel (5) being connected to the microfluidic channel by its inlet (7) and outlet (8), such that its outlet (8) coincides with the obstruction (4a, 4b),
wherein the side channel (5) is an area of shallowing the microfluidic channel (1) at the side of the microfluidic channel (1) looking along the direction of the flow, such that the transverse dimension h3 of the side channel (5), as measured in the first direction perpendicular to the direction of flow, is h3<h1,
and wherein any line fluidically connecting a point A before the inlet (7) of the side channel (5) and a point B behind the outlet (8) of the side channel (5) along the direction of flow must extend through a shallower area of h2<h1 or h3<h1,
wherein the lumen of the side channel (5) at a position of the inlet (7) and the outlet (8) of the side channel (5) is less than the lumen of the microfluidic channel (1) between inlet (7) and outlet (8),
such that the channel geometry and Laplace pressure related the surface tension on and curvature of the surface of a droplet cause separation of the flow of the continuous phase through the side channel (5) from the flow of the droplet through the microfluidic channel (1).
